(19) United States
(12) Patent Application Publication
(10) Pub. No.: US 2026/0279675 A1
(43) Pub. Date: Sep. 17, 2026

(54) ELECTRONIC COMPONENT

(71) Applicant: TDK Corporation, Tokyo (JP)

(72) Inventors: Takaaki SATO, Tokyo (JP); Masahiro MORI, Tokyo (JP); Shinya ITO, Tokyo (JP); Norihisa ANDO, Tokyo (JP)

(73) Assignee: TDK Corporation, Tokyo (JP)

(21) Appl. No.: 19/563,006

(22) Filed: Mar. 11, 2026

(30) Foreign Application Priority Data
Mar. 14, 2025 (JP) 2025-041003

(51) Int. Cl. H01G 4/236

(52) U.S. Cl. CPC H01G 4/236

(57) ABSTRACT

Each of first and second metal terminals includes an inner portion located inside an exterior body and an outer portion located outside the exterior body. The exterior body includes a main surface arranged to constitute a mounting surface, and first and second side surfaces that are adjacent to the main surface and oppose each other. A ceramic body is located on one side of a plane that includes a first position on the first side surface at which the first metal terminal is exposed and a second position on the second side surface at which the second metal terminal is exposed. The ceramic body and the outer portion of the first metal terminal are configured such that the ceramic body and the outer portion overlap each other in a view from a side of the first side surface in a direction parallel to the main surface and the plane.

### CROSS-REFERENCE TO RELATED APPLICATIONS

This application is based upon and claims the benefit of priority from Japanese Patent Application No. 2025-041003, filed on Mar. 14, 2025, the entire contents of which are incorporated herein by reference.

### BACKGROUND

### Field

One aspect of the present disclosure relates to an electronic component.

### Description of the Related Art

Known electronic components include a ceramic body including a pair of main surfaces opposing each other, a pair of electrodes respectively disposed on the pair of main surfaces, a pair of metal terminals respectively connected to the pair of electrodes, and an exterior body (see, for example, Japanese Unexamined Patent Publication No. 2023-182274). The exterior body covers, for example, the ceramic body, the pair of electrodes, and a part of each of the pair of metal terminals.

### SUMMARY

An electronic component according to one aspect of the present disclosure includes a ceramic body including a first main surface and a second main surface opposing each other and a side surface coupling the first main surface and the second main surface, a first electrode disposed on the first main surface, a second electrode disposed on the second main surface, a first metal terminal connected to the first electrode, a second metal terminal connected to the second electrode, and an exterior body covering the ceramic body, the first electrode, the second electrode, a part of the first metal terminal, and a part of the second metal terminal. The exterior body includes a third main surface that opposes the side surface and is arranged to constitute a mounting surface, and a first side surface and a second side surface that oppose the side surface, are adjacent to the third main surface, and oppose each other. The first metal terminal is exposed from the exterior body at the first side surface, and includes a first inner portion located in the exterior body and a first outer portion located outside the exterior body. The second metal terminal is exposed from the exterior body at the second side surface, and includes a second inner portion located in the exterior body and a second outer portion located outside the exterior body. The ceramic body is located on one side of a plane that is perpendicular to the third main surface and includes a first position on the first side surface at which the first metal terminal is exposed and a second position on the second side surface at which the second metal terminal is exposed. The ceramic body and the first outer portion are configured such that the ceramic body and the first outer portion overlap each other in a view from a side of the first side surface in a direction parallel to the third main surface and the plane. The ceramic body and the second outer portion are configured such that the ceramic body and the second outer portion overlap each other in a view from a side of the second side surface in a direction parallel to the third main surface and the plane.

### BRIEF DESCRIPTION OF THE DRAWINGS

FIG. 1 is a perspective view illustrating an electronic component according to an example;

FIG. 2 is a perspective view illustrating the electronic component according to the present example;

FIGS. 3A and 3B are side views of the electronic component according to the present example;

FIG. 4 is a diagram illustrating a cross-sectional configuration of the electronic component according to the present example;

FIG. 5 is a diagram illustrating a cross-sectional configuration of the electronic component according to the present example;

FIG. 6 is a perspective view illustrating a ceramic element;

FIG. 7 is a perspective view illustrating a metal terminal;

FIG. 8 is a perspective view illustrating a metal terminal;

FIG. 9 is a perspective view illustrating a metal terminal;

FIG. 10 is a perspective view illustrating a metal terminal;

FIG. 11 is a diagram illustrating a pair of metal terminals;

FIG. 12 is a diagram illustrating a pair of metal terminals;

FIG. 13 is a schematic diagram illustrating a configuration of a ceramic element and an exterior body;

FIG. 14 is a diagram illustrating a modification of a pair of metal terminals; and

FIG. 15 is a schematic diagram illustrating a configuration of a ceramic element and an exterior body.

### DETAILED DESCRIPTION

In the following description, with reference to the drawings, the same reference numbers are assigned to the same components or to similar components having the same function, and overlapping description is omitted.

An electronic component is typically mounted on an electronic device. The electronic device includes, for example, a circuit board or another electronic component.

One aspect of the present disclosure provides an electronic component that can increase fixing strength to an electronic device.

One aspect of the present disclosure relates to an electronic component that includes a ceramic body including a first main surface and a second main surface opposing each other and a side surface coupling the first main surface and the second main surface, a first electrode disposed on the first main surface, a second electrode disposed on the second main surface, a first metal terminal connected to the first electrode, a second metal terminal connected to the second electrode, and an exterior body covering the ceramic body, the first electrode, the second electrode, a part of the first metal terminal, and a part of the second metal terminal. The exterior body includes a third main surface that opposes the side surface and is arranged to constitute a mounting surface, and a first side surface and a second side surface that oppose the side surface, are adjacent to the third main surface, and oppose each other. The first metal terminal is exposed from the exterior body at the first side surface, and includes a first inner portion located in the exterior body and a first outer portion located outside the exterior body. The second metal terminal is exposed from the exterior body at the second side surface, and includes a second inner portion located in the exterior body and a second outer portion located outside the exterior body. The ceramic body is located on one side of a plane that is perpendicular to the third main surface and includes a first position on the first side surface at which the first metal terminal is exposed and a second position on the second side surface at which the second metal terminal is exposed. The ceramic body and the first outer portion are configured such that the ceramic body and the first outer portion overlap each other in a view from a side of the first side surface in a direction parallel to the third main surface and the plane. The ceramic body and the second outer portion are configured such that the ceramic body and the second outer portion overlap each other in a view from a side of the second side surface in a direction parallel to the third main surface and the plane.

The electronic component according to the one aspect is mounted on an electronic device such that the third main surface opposes the electronic device.

In the one aspect, a portion of the first metal terminal exposed from the exterior body, including the first outer portion, tends to contribute to the fixing strength of the electronic component to the electronic device. Similarly, a portion of the second metal terminal exposed from the exterior body, including the second outer portion, tends to contribute to the fixing strength of the electronic component to the electronic device. The first metal terminal is exposed from the exterior body at the first side surface, and the second metal terminal is exposed from the exterior body at the second side surface. Therefore, the one aspect can increase the size of a portion contributing to the fixing strength, as compared to a configuration in which the first metal terminal and the second metal terminal are exposed from the exterior body at the mounting surface.

In the one aspect, the ceramic body is located on the one side of the plane, and the ceramic body and the first outer portion are configured such that the ceramic body and the first outer portion overlap each other in a view from a side of the first side surface in a direction parallel to the third main surface and the plane, and the ceramic body and the second outer portion are configured such that the ceramic body and the second outer portion overlap each other in a view from a side of the second side surface in a direction parallel to the third main surface and the plane. Therefore, the one aspect can increase the size of each of the first outer portion and the second outer portion.

Consequently, the one aspect can increase the fixing strength to the electronic device.

In the one aspect, the ceramic body and the first inner portion may be configured such that the ceramic body and the first inner portion overlap each other in a view from a side of the first side surface in a direction parallel to the third main surface and the plane. The ceramic body and the second inner portion may be configured such that the ceramic body and the second inner portion do not overlap each other in a view from a side of the second side surface in a direction parallel to the third main surface and the plane.

In a configuration in which the ceramic body and the first inner portion overlap each other as described above and the ceramic body and the second inner portion do not overlap each other as described above, this configuration can reliably increase the fixing strength to the electronic device.

In the one aspect, the exterior body may include a third side surface opposing the second main surface in a direction perpendicular to the plane, and a fourth side surface opposing the first main surface in the direction perpendicular to the plane. In the direction perpendicular to the plane, a distance between the fourth side surface and the ceramic body may be larger than a distance between the third side surface and the ceramic body.

In a configuration in which the distance between the fourth side surface and the ceramic body is larger than the distance between the third side surface and the ceramic body as described above, this configuration can further increase the fixing strength to the electronic device.

In the one aspect, the first inner portion may include a first connection portion connected to the first electrode, and a first bridge portion bridging the first connection portion and the first outer portion.

The second inner portion may include a second connection portion connected to the second electrode, and a second bridge portion bridging the second connection portion and the second outer portion. The first bridge portion may include a first region extending to oppose the first main surface, a second region that is continuous with the first region and extends to oppose the side surface of the ceramic body, and a third region that is continuous with the second region and extends toward the first side surface in a direction intersecting a direction in which the second region extends. The second bridge portion may include a fourth region extending to oppose the second main surface.

In a configuration in which the first inner portion includes the first connection portion and the first bridge portion including the first region, the second region, and the third region, as described above, and the second inner portion includes the second connection portion and the second bridge portion including the fourth region, as described above, this configuration stably supports the ceramic body located on the one side of the plane.

In the one aspect, the first connection portion and the second connection portion may have a rectangular shape as viewed from a direction in which the first main surface and the second main surface oppose each other, and may be located such that one corner of the rectangular shape had by the first connection portion and one corner of the rectangular shape had by the second connection portion overlap each other in the direction in which the first main surface and the second main surface oppose each other. The first bridge portion may be connected to another corner that is adjacent to the one corner overlapping the second connection portion and is exposed from the second connection portion, among a plurality of corners of the rectangular shape had by the first connection portion. The second bridge portion may be connected to another corner that is adjacent to the one corner overlapping the first connection portion and is exposed from the first connection portion, among a plurality of corners of the rectangular shape had by the second connection portion.

In a configuration in which the first connection portion and the second connection portion are located as described above, and the first bridge portion is connected to the other corner described above, and the second bridge portion is connected to the other corner described above, the ceramic body can be stably supported by the first metal terminal (first connection portion) and the second metal terminal (second connection portion).

In the one aspect, the first region may include a region including an end closer to the first connection portion and a region including an end closer to the second region, and may have an L-shape as viewed from the direction in which the first main surface and the second main surface oppose each other. The fourth region may include a region including an end closer to the second connection portion and a region including an end closer to the second outer portion, may have has a T-shape as viewed from the direction in which the first main surface and the second main surface oppose each other.

In a configuration in which the first region has an L-shape as described above and the fourth region has a T-shape as described above, the first bridge portion and the second bridge portion can have an elastic force. The elastic force that the first bridge portion has can generate a force toward the ceramic body on the first connection portion. The elastic force that the second bridge portion has can generate a force toward the ceramic body on the second connection portion. Therefore, the ceramic body can be supported more stably.

In the one aspect, the first connection portion may be connected to the first electrode in a region overlapping the second connection portion in the direction in which the first main surface and the second main surface oppose each other. The second connection portion may be connected to the second electrode in a region overlapping the first connection portion in the direction in which the first main surface and the second main surface oppose each other.

In a configuration in which the first connection portion is connected to the first electrode as described above and the second connection portion is connected to the second electrode as described above, a region in which the first connection portion and the first electrode are connected and a region in which the second connection portion and the second electrode are connected can overlap in the direction in which the first main surface and the second main surface oppose each other. Therefore, in this configuration, the ceramic body can be more stably supported by the first metal terminal and the second metal terminal.

In the one aspect, the one corner of the first connection portion to which the first bridge portion is connected and the one corner of the second connection portion to which the second bridge portion is connected may be located on opposite sides with a region in which the first connection portion and the second connection portion overlap each other interposed therebetween, as viewed from the direction in which the first main surface and the second main surface oppose each other.

In a configuration in which the one corner of the first connection portion to which the first bridge portion is connected and the one corner of the second connection portion to which the second bridge portion is connected are located as described above, the ceramic body can be more stably supported by the first metal terminal and the second metal terminal.

In the one aspect, the first region may be separated from the first electrode. The first bridge portion may include a region connecting the first region and the first connection portion. The fourth region may be separated from the second electrode. The second bridge portion may include a region connecting the fourth region and the second connection portion.

In a configuration in which the first region is separated from the first electrode and the fourth region is separated from the second electrode, this configuration suppresses the occurrence of an unintended short circuit between the first electrode and the second electrode.

In the one aspect, the exterior body may include a third side surface opposing the second main surface in a direction perpendicular to the plane, and a fourth side surface opposing the first main surface in the direction perpendicular to the plane. Each of the first side surface and the second side surface may include a first surface region located closer to the third side surface than the plane, and a second surface region located closer to the fourth side surface than the plane. The first surface regions included in the first side surface and the second side surface may be inclined such that a distance between the first surface regions decreases with increasing distance from the plane. The second surface regions included in the first side surface and the second side surface may be inclined such that a distance between the second surface regions decreases with increasing distance from the plane.

In a configuration in which the first surface regions included in the first side surface and the second side surface are inclined as described above, and the second surface regions included in the first side surface and the second side surface are inclined as described above, this configuration can reduce the volume of the exterior body as compared to a configuration in which the first surface regions included in the first side surface and the second side surface are not inclined as described above, and the second surface regions included in the first side surface and the second side surface are not inclined as described above. The reduction in the volume of the exterior body leads to a reduction in the weight of the electronic component. Therefore, stress generated by vibration of the electronic component can be relaxed.

In the one aspect, the exterior body may include a third side surface opposing the second main surface in a direction perpendicular to the plane, and a fourth side surface opposing the first main surface in the direction perpendicular to the plane. The ceramic body may be located closer to the fourth side surface than the plane.

In a configuration in which the ceramic body is located closer to the fourth side surface than the plane reliably, this configuration realizes a configuration in which the ceramic body is located on the one side of the plane.

In the one aspect, in the direction perpendicular to the plane, a distance between the plane and the fourth side surface may be larger than a distance between the plane and the third side surface.

In a configuration in which the distance between the plane and the fourth side surface is larger than the distance between the plane and the third side surface as described above, this configuration can further increase the size of each of the first outer portion and the second outer portion. Therefore, this configuration can further increase the fixing strength to the electronic device.

In the one aspect, the first outer portion may include an outer region extending from the first position along the first side surface. The second outer portion may include an outer region extending from the second position along the second side surface.

In a configuration in which the first outer portion includes the outer region as described above and the second outer portion includes the outer region as described above, the electronic component is reliably mounted on the electronic device.

In the one aspect, the exterior body may include a third side surface opposing the second main surface in a direction perpendicular to the plane, and a fourth side surface opposing the first main surface in the direction perpendicular to the plane. Each of the third side surface and the fourth side surface may include a first surface region located closer to the first side surface and a second surface region located closer to the second side surface. The first surface regions included in the third side surface and the fourth side surface may be inclined relative to the plane such that a distance between the first surface regions decreases with decreasing distance to the first side surface. The second surface regions included in the third side surface and the fourth side surface may be inclined relative to the plane such that a distance between the second surface regions decreases with decreasing distance to the second side surface.

In a configuration in which the first surface regions included in the third side surface and the fourth side surface are inclined as described above, and the second surface regions included in the third side surface and the fourth side surface are inclined as described above, the electronic component tends not to fall in the direction perpendicular to the plane. Therefore, this configuration improves the vibration resistance of the electronic component.

In the one aspect, the first outer portion may include a first outer region along the first side surface and a second outer region extending in a direction intersecting the first outer region. The second outer portion may include a third outer region along the second side surface and a fourth outer region extending in a direction intersecting the third outer region.

In a configuration in which the first outer portion includes the first outer region and the second outer region as described above, and the second outer portion includes the third outer region and the fourth outer region as described above, the electronic component is reliably mounted on the electronic device.

In the one aspect, the second outer region and the fourth outer region may be along the third main surface. The third main surface may be provided with a recess at each of a position corresponding to the second outer region and a position corresponding to the fourth outer region.

A configuration in which the recess is not provided in the third main surface increases the height of the electronic component in a direction perpendicular to the third main surface by the thickness of each of the second outer region and the fourth outer region. In contrast, a configuration in which the recess is provided in the third main surface as described above can suppress an increase in the height of the electronic component in the direction perpendicular to the third main surface.

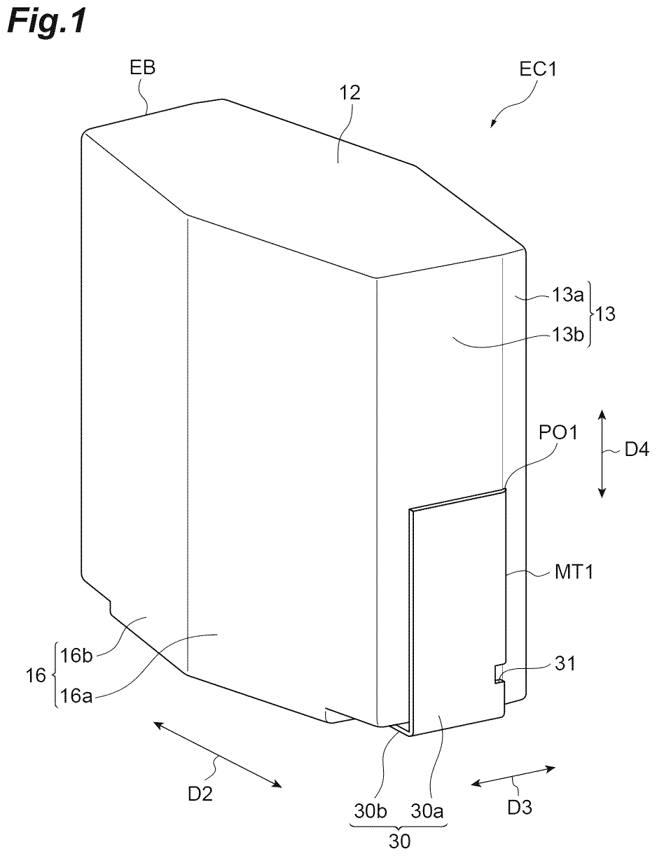

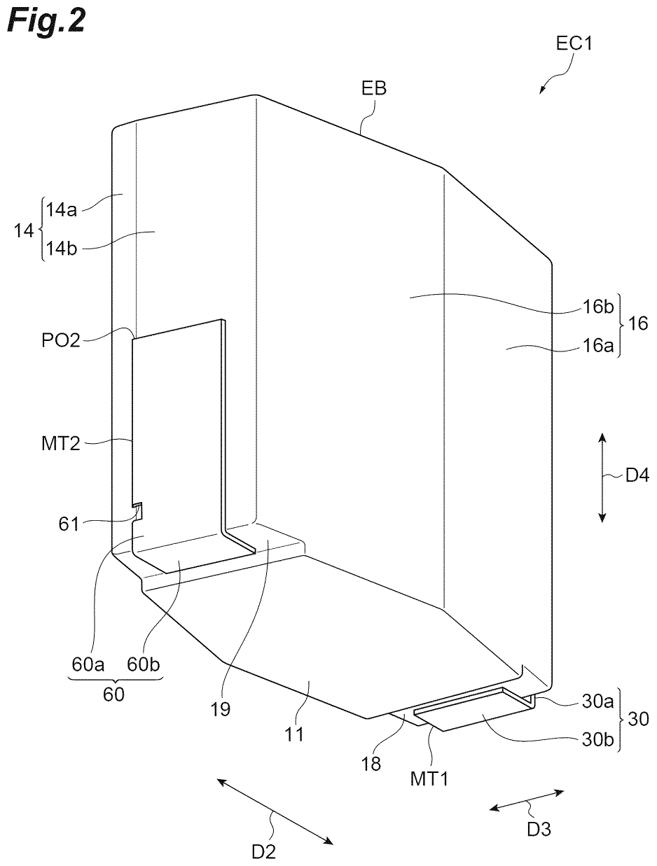

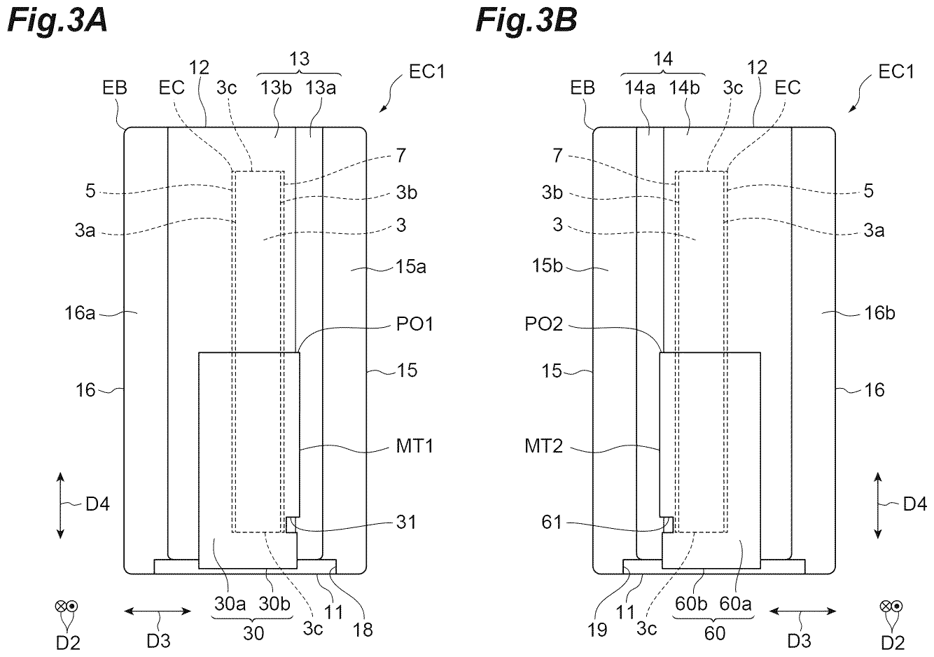

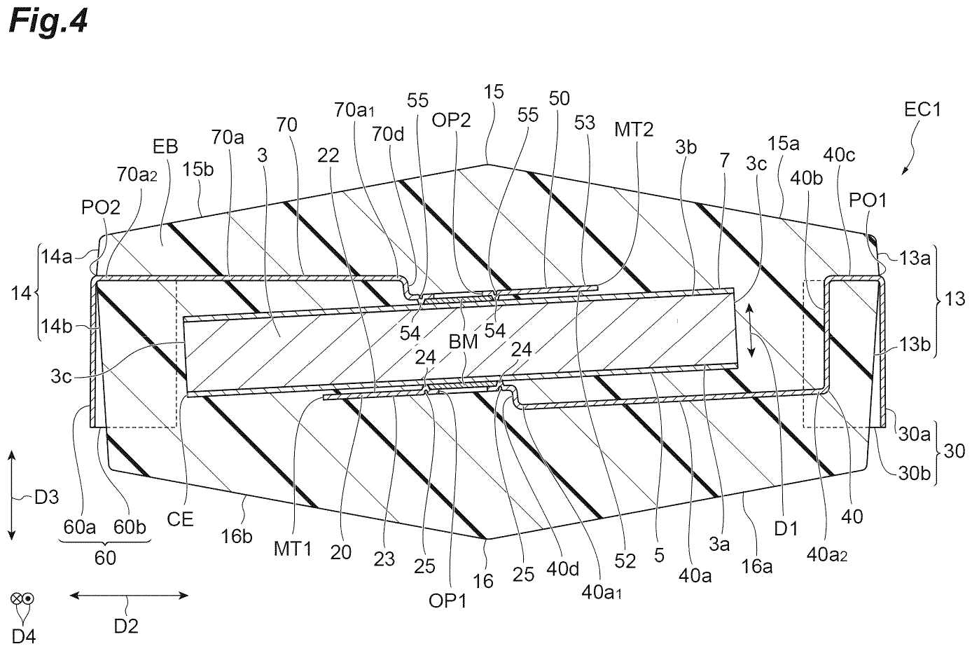

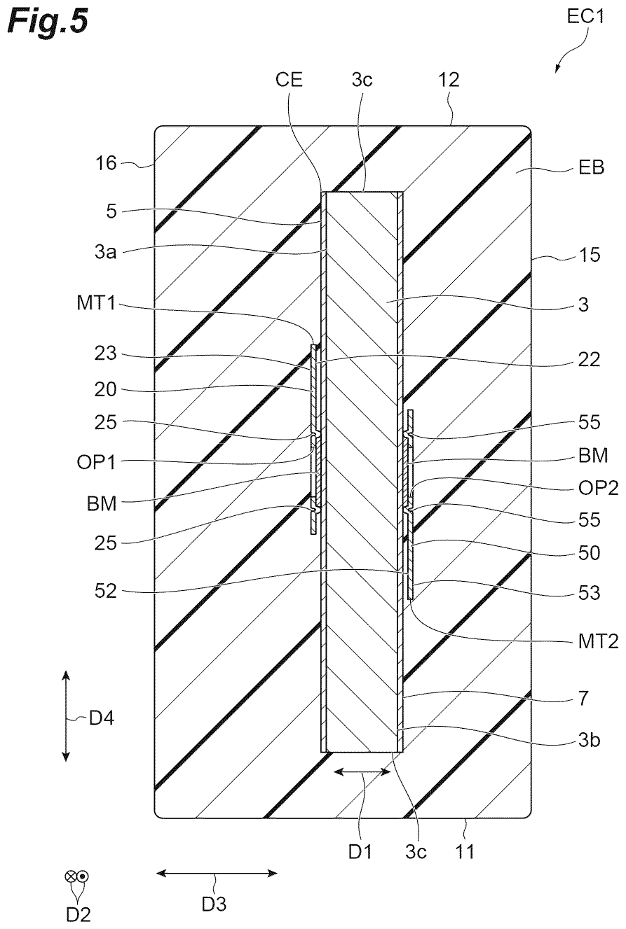

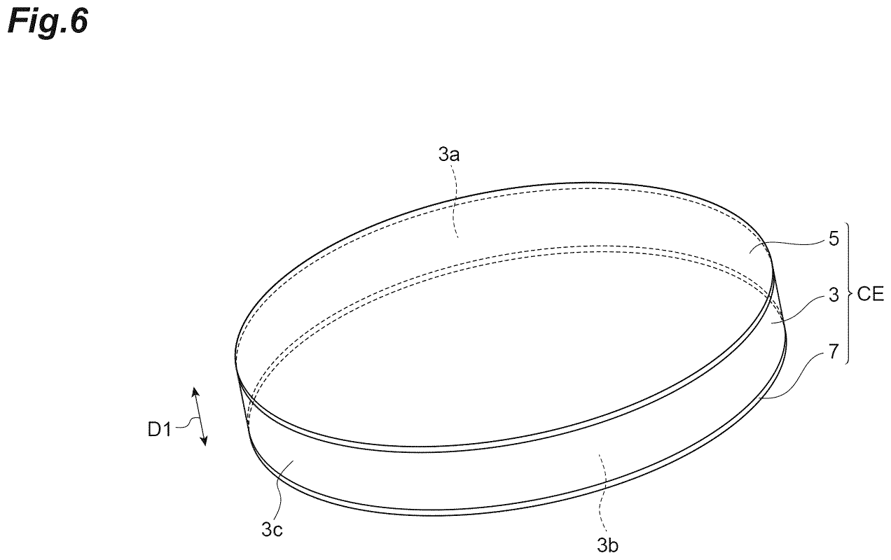

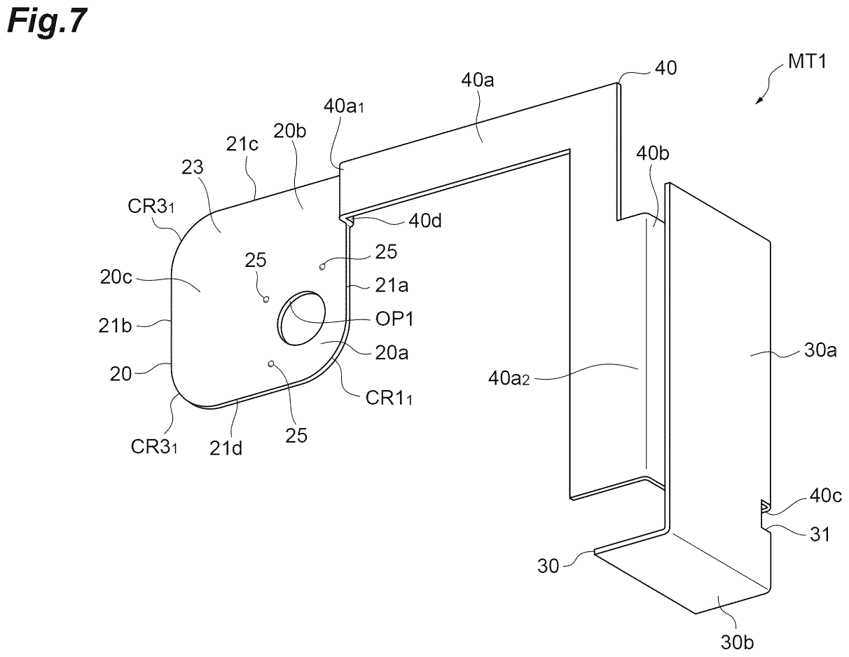

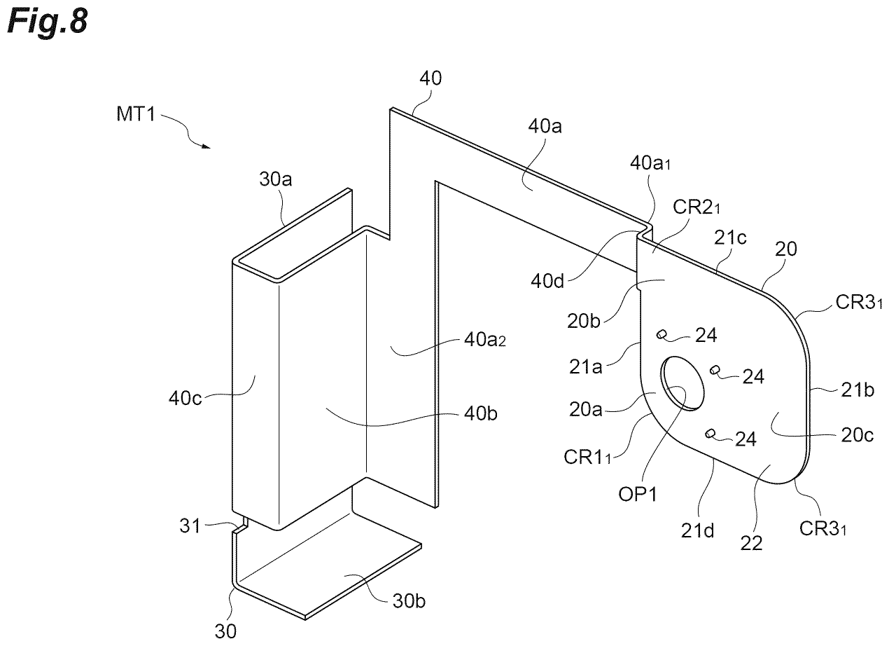

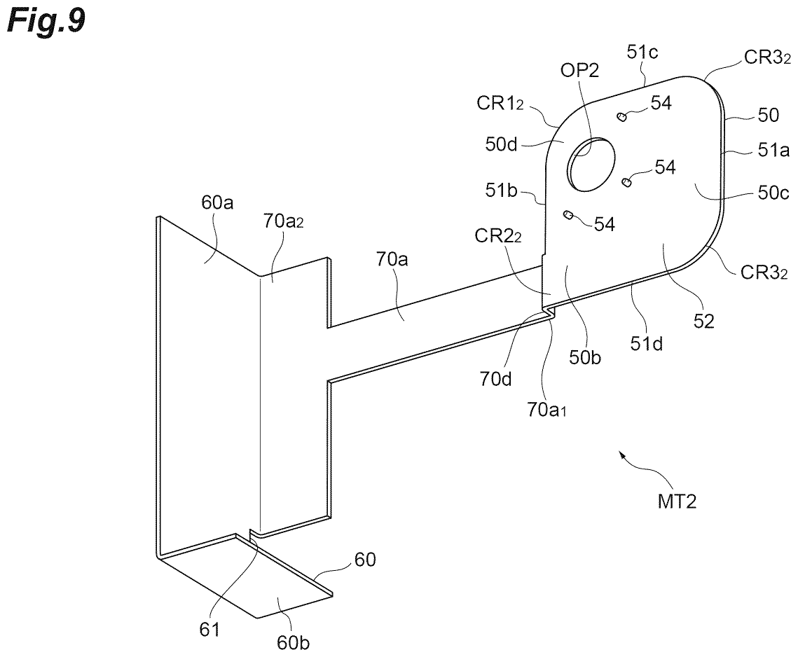

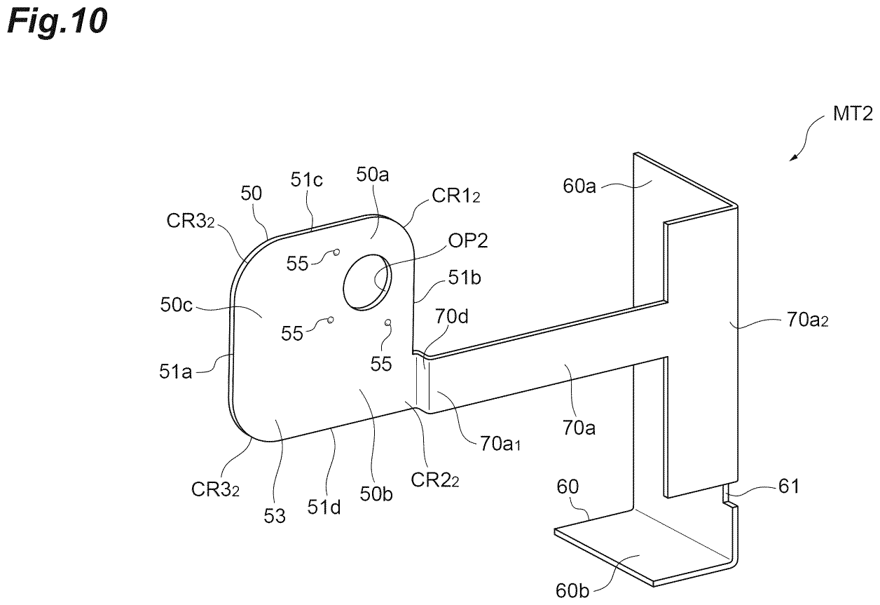

The configuration of an electronic component EC1 according to the present example will be described with reference to FIGS. 1 to 10. FIG. 1 and FIG. 2 are perspective views illustrating the electronic component according to the present example. FIGS. 3A and 3B are side views of the electronic component according to the present example. FIG. 4 and FIG. 5 are diagrams illustrating a cross-sectional configuration of the electronic component according to the present example. FIG. 6 is a perspective view illustrating a ceramic element. FIG. 7, FIG. 8, FIG. 9, and FIG. 10 are perspective views illustrating a metal terminal.

As illustrated in FIGS. 1 to 5, the electronic component EC1 includes a ceramic element CE, a plurality of metal terminals MT1 and MT2, and an exterior body EB. The ceramic element CE includes a ceramic body 3 and a plurality of electrodes 5 and 7. The electronic component EC1 includes, for example, a pair of electrodes 5 and 7 and a pair of metal terminals MT1 and MT2. The electronic component EC1 includes, for example, a capacitor component.

The electronic component EC1 is mounted on an electronic device. The electronic component EC1 is, for example, solder-mounted on an electronic device. The electronic device includes, for example, a circuit board or another electronic component.

As illustrated in FIGS. 3A to 6, the ceramic body 3 includes a pair of main surfaces 3a and 3b and a side surface 3c. The pair of main surfaces 3a and 3b oppose each other in a direction D1. The side surface 3c couples the pair of main surfaces 3a and 3b. The side surface 3c extends in the direction D1. For example, the main surface 3a may include a first main surface, and the main surface 3b may include a second main surface.

The ceramic body 3 has, for example, a plate shape. The ceramic body 3 includes, for example, an integral ceramic plate. The ceramic body 3 has a circular shape as viewed from a direction perpendicular to the pair of main surfaces 3a and 3b. The circular shape includes a true circle shape or an oval shape. The oval shape includes an elliptical shape or a rounded rectangular shape. The ceramic body 3 may have a polygonal shape as viewed from a direction perpendicular to the pair of main surfaces 3a and 3b. The polygonal shape includes, for example, a shape in which each corner is chamfered or a shape in which each corner is rounded.

The ceramic body 3 includes, for example, a dielectric ceramic. The dielectric ceramic includes, for example, a BaTiO₃-based, CaTiO₃-based, SrTiO₃-based, or CaZrO₃-based dielectric ceramic. The ceramic body 3 may include, for example, a piezoelectric ceramic, a semiconductor ceramic, or a magnetic ceramic instead of the dielectric ceramic. The ceramic body 3 includes, for example, a capacitor body.

A ceramic element CE in which the ceramic body 3 includes a dielectric ceramic includes, for example, a capacitor element. A ceramic element CE in which the ceramic body 3 includes a piezoelectric ceramic includes, for example, a piezoelectric element. A ceramic element CE in which the ceramic body 3 includes a semiconductor ceramic includes, for example, a varistor element or a thermistor element. A ceramic element CE in which the ceramic body 3 includes a magnetic ceramic includes, for example, a coil element. The ceramic element CE may include an internal conductor disposed in the ceramic body 3 and electrically connected to the pair of electrodes 5 and 7.

The electrode 5 is disposed on the main surface 3a. The electrode 5 covers the main surface 3a. For example, the electrode 5 covers the entire main surface 3a. The electrode 5 is in contact with the main surface 3a. The electrode 7 is disposed on the main surface 3b. The electrode 7 covers the main surface 3b. For example, the electrode 7 covers the entire main surface 3b. The electrode 7 is in contact with the main surface 3b. The side surface 3c is exposed from the pair of electrodes 5 and 7. The side surface 3c is not covered by the pair of electrodes 5 and 7. The pair of electrodes 5 and 7 are separated from each other in the direction D1. The ceramic body 3 is located between the pair of electrodes 5 and 7. For example, the electrode 5 may include a first electrode, and the electrode 7 may include a second electrode.

The electrodes 5 and 7 include an electrically conductive metal material. The metal material includes, for example, Cu, Ni, Cr, Ag, Pd, Au, or Ti. The metal material may include, for example, an Ag—Pd alloy, a Cu—Ni alloy, a Cu—Ti alloy, a Ni—Cr alloy, or a Ni—Ti alloy. The electrodes 5 and 7 may have a single-layer structure or a multilayer structure. The electrodes 5 and 7 may include a sintered metal layer or a plating layer. The sintered metal layer is formed, for example, by sintering an electrically conductive paste applied to the ceramic body 3. The plating layer is formed, for example, through a plating process. The plating process includes an electrolytic plating process, an electroless plating process, a physical vapor deposition process, or a chemical vapor deposition process.

As illustrated in FIGS. 4 and 5, the pair of metal terminals MT1 and MT2 sandwich the ceramic body 3. The pair of metal terminals MT1 and MT2 hold the ceramic body 3 therebetween. The pair of metal terminals MT1 and MT2 have electrical conductivity. The metal terminal MT1 is connected to the electrode 5. The metal terminal MT1 is electrically and physically connected to the electrode 5. The metal terminal MT1 is joined to the electrode 5 by an electrically conductive joining material BM. The metal terminal MT2 is connected to the electrode 7. The metal terminal MT2 is electrically and physically connected to the electrode 7. The metal terminal MT2 is joined to the electrode 7 by an electrically conductive joining material BM. The electrically conductive joining material BM includes, for example, solder. For example, the metal terminal MT1 may include a first metal terminal, and the metal terminal MT2 may include a second metal terminal.

The metal terminals MT1 and MT2 include, for example, a metal base and a plating film formed on the metal base. The metal base includes, for example, Fe, Ni, Cu, Ag, or Cr. The metal base includes, for example, an Fe—Cr alloy, an Fe—Ni alloy, or a Cu—Sn alloy. The plating film includes, for example, Sn, Ni, Cu, Ag, or Au. The plating film may have a single-layer structure or a multilayer structure. The metal terminals MT1 and MT2 are made of, for example, a lead frame.

The exterior body EB covers the ceramic body 3, the pair of electrodes 5 and 7, at least a part of the metal terminal MT1, and at least a part of the metal terminal MT2. For example, a part of each of the metal terminals MT1 and MT2 is located outside the exterior body EB and is exposed from the exterior body EB. The exterior body EB includes, for example, a resin. The exterior body EB is made of, for example, a resin. The resin includes, for example, a thermosetting resin. The thermosetting resin includes, for example, an epoxy resin, a silicone resin, a phenol resin, an acrylic resin, or a polyimide resin. The exterior body EB is formed, for example, through a molding process. The molding process includes, for example, an injection molding process or a transfer molding process.

As illustrated in FIGS. 1 to 5, the exterior body EB includes a plurality of side surfaces 11, 12, 13, 14, 15, and 16. The exterior body EB includes, for example, a pair of side surfaces 11 and 12 opposing each other, a pair of side surfaces 13 and 14 opposing each other, and a pair of side surfaces 15 and 16 opposing each other. The exterior body EB has a polyhedral shape.

The side surface 11 opposes the side surface 3c. In the electronic component EC1, the side surface 11 opposes the electronic device. The side surface 11 is arranged to constitute a mounting surface. The side surface 11 includes a mounting surface. The side surface 12 opposes the side surface 3c. The side surface 11 and the side surface 12 oppose each other in a direction D4. For example, the direction D4 intersects the direction D1. The side surface 11 may include a third main surface, and the side surface 12 may include a fourth main surface.

The pair of side surfaces 13 and 14 are adjacent to the side surfaces 11 and 12, and couple the side surfaces 11 and 12. The pair of side surfaces 13 and 14 oppose the side surface 3c. The side surfaces 11 and 12 couple the pair of side surfaces 13 and 14. The pair of side surfaces 13 and 14, for example, substantially oppose each other in a direction D2. The side surface 13 may include a first side surface, and the side surface 14 may include a second side surface.

The pair of side surfaces 15 and 16 are adjacent to the side surfaces 11 and 12, and couple the side surfaces 11 and 12. The pair of side surfaces 15 and 16 are adjacent to the side surfaces 13 and 14, and couple the side surfaces 13 and 14. The side surface 15 opposes the main surface 3b. The side surface 16 opposes the main surface 3a. The pair of side surfaces 15 and 16, for example, substantially oppose each other in a direction D3. For example, the direction D2, the direction D3, and the direction D4 are substantially perpendicular to each other. The side surface 15 may include a third side surface, and the side surface 16 may include a fourth side surface. The side surface 11 couples the pair of side surfaces 13 and 14, and couples the pair of side surfaces 15 and 16. The side surface 11 may include a fifth side surface.

As illustrated in FIG. 4, the metal terminal MT1 includes one end located inside the exterior body EB and another end located outside the exterior body EB. The other end of the metal terminal MT1 is exposed from the exterior body EB. As illustrated in FIGS. 7 and 8, the metal terminal MT1 includes a connection portion 20, a mounting portion 30, and a bridge portion 40.

The connection portion 20 is located on the one end side of the metal terminal MT1. The mounting portion 30 is located on the other end side of the metal terminal MT1. The bridge portion 40 bridges the connection portion 20 and the mounting portion 30. The bridge portion 40 is located between the connection portion 20 and the mounting portion 30. The bridge portion 40 is located closer to the side surface 13 than the connection portion 20. For example, the bridge portion 40 is continuous with the connection portion 20 and is continuous with the mounting portion 30. The bridge portion 40 extends from the connection portion 20. The bridge portion 40 extends, for example, from the connection portion 20 toward the side surface 13, generally in the direction D2.

As illustrated in FIG. 3A, the metal terminal MT1 is exposed from the exterior body EB at the side surface 13. The connection portion 20 and the bridge portion 40 are located inside the exterior body EB. The mounting portion 30 is located outside the exterior body EB. The connection portion 20 and the bridge portion 40 may include a first inner portion, and the mounting portion 30 may include a first outer portion.

The connection portion 20 is connected to the electrode 5. The connection portion 20 opposes the electrode 5. The connection portion 20 is parallel to the main surface 3a. “Parallel” includes not only completely parallel but also “substantially parallel”. A configuration in which two parts are substantially parallel includes a configuration in which the two parts have an angle due to a manufacturing error or a measurement error. The ratio of the area of the connection portion 20 to the area of the main surface 3a is from 110% to 41%. The area of the main surface 3a is, for example, from 7.05 to 95.05 mm², and the area of the connection portion 20 is, for example, from 5.44 to 22.89 mm².

The connection portion 20 includes a plurality of regions 20a, 20b, and 20c. For example, the connection portion 20 includes three regions 20a, 20b, and 20c. The region 20a opposes the electrode 5. The region 20a is joined to the electrode 5 by the electrically conductive joining material BM. The region 20a is joined to the electrode 5 by surface contact. The region 20b is separated from the electrode 5 and is continuous with the bridge portion 40. The region 20b is not directly joined to the electrode 5. The region 20c is continuous with the region 20a and the region 20b. The region 20b may not be separated from the electrode 5. The region 20b may be in contact with the electrode 5. The region 20a may include a first region included in the connection portion 20, the region 20b may include a second region included in the connection portion 20, and the region 20c may include a fifth region included in the connection portion 20.

The connection portion 20 has, for example, a polygonal shape as viewed from the direction D1. The connection portion 20 has, for example, a rectangular shape as viewed from the direction D1. The polygonal shape (rectangular shape) includes, as described above, a shape in which each corner is chamfered or a shape in which each corner is rounded. The connection portion 20 may have a circular shape as viewed from the direction D1.

The connection portion 20 includes a plurality of edges 21a, 21b, 21c, and 21d. The plurality of edges 21a, 21b, 21c, and 21d define the outer shape of the connection portion 20 as viewed from the direction D1. The connection portion 20 includes, for example, a pair of edges 21a and 21b opposing each other, and a pair of edges 21c and 21d opposing each other. The pair of edges 21a and 21b oppose each other, for example, in a direction in which the bridge portion 40 extends from the connection portion 20. The pair of edges 21c and 21d substantially oppose each other in a direction intersecting the direction in which the pair of edges 21a and 21b oppose each other. The pair of edges 21c and 21d, for example, substantially oppose each other in a direction perpendicular to the direction in which the pair of edges 21a and 21b oppose each other. The pair of edges 21c and 21d, for example, substantially oppose each other in the direction D3. For example, the edge 21a may include a first edge, the edge 21b may include a second edge, the edge 21c may include a fifth edge, and the edge 21d may include a sixth edge.

In a configuration in which the connection portion 20 has a polygonal shape as described above, the connection portion 20 includes a plurality of corners as viewed from the direction D1. The connection portion 20 includes, for example, four corners.

The region 20a includes one corner CR1₁ among the plurality of corners included in the connection portion 20. The region 20b includes another corner CR2₁ among the plurality of corners included in the connection portion 20, the other corner CR2₁ being different from the corner CR1₁ included in the region 20a. The corner CR2₁ is adjacent to the corner CR11. The region 20c includes a plurality of corners CR3₁ among the plurality of corners included in the connection portion 20, the plurality of corners CR3₁ being different from the two corners CR11 and CR2₁ included in the regions 20a and 20b. The region 20c includes, for example, two corners CR3₁. One corner CR3₁ of the plurality of corners CR3₁ is adjacent to the corner CR1₁. Another corner CR3₁ of the plurality of corners CR3₁ is adjacent to the corner CR2₁.

The corner CR1₁ and the two corners CR3₁ are curved as viewed from the direction D1. The corner CR1₁ and the two corners CR3₁ have an arc shape as viewed from the direction D1. The bridge portion 40 is continuous with one of two sides defining the corner CR2₁ included in the region 20b.

An opening OP1 is formed in the region 20a. The opening OP1 penetrates the region 20a. The opening OP1 is located at the center of the main surface 3a as viewed from the direction in which the pair of main surfaces 3a and 3b oppose each other, that is, the direction D1. The opening OP1 is located closer to the corner CR11 in the connection portion 20.

The opening OP1 has, for example, a circular shape as viewed from the direction D1. The opening OP1 may have a polygonal shape as viewed from the direction D1. “Center” does not mean only one center point equidistant from all points on the edge of the region 20a that defines the opening OP1. Even at a position separated from the above-described center point, when the distance from the above-described center point includes a minute difference within a predetermined range, a manufacturing error, or a measurement error, it may be regarded as “center”. The predetermined range may be set, for example, in a range of ±3% of the equivalent circle diameter of the opening OP1.

The region 20a includes a pair of surfaces 22 and 23 opposing each other. The surface 22 opposes the electrode 5. A plurality of protrusions 24 are provided on the surface 22 of the region 20a. For example, three protrusions 24 are formed in the region 20a. A plurality of recesses 25 are provided at positions corresponding to the plurality of protrusions 24 on the surface 23 of the region 20a. The respective tops of the plurality of protrusions 24 are in contact with the electrode 5. The region 20a is in contact with the electrode 5 at the plurality of protrusions 24. The surface 22 and the electrode 5 are in contact with each other at, for example, three locations. The surface 22 is separated from the electrode 5 by the height of the protrusions 24, except for the locations at which the plurality of protrusions 24 are located. The electrically conductive joining material BM that joins the region 20a and the electrode 5 is disposed in a gap between the surface 22 and the electrode 5. This electrically conductive joining material BM is in contact with the surface 22 and the electrode 5. The height of the protrusions 24 is, for example, from 0.05 to 0.20 mm. The surface 22 may include a first surface, and the surface 23 may include a second surface.

The plurality of protrusions 24 are located along the edge of the opening OP1. The plurality of protrusions 24 are formed along the edge of the opening OP1, except between the edge of the opening OP1 and the corner CR1₁. The plurality of protrusions 24 are located, for example, at equal intervals. “Equal intervals” includes, for example, that a plurality of intervals are equal to each other, that a difference between the plurality of intervals is within a range of a predetermined minute difference, or that a difference between the plurality of intervals is within a manufacturing error. For example, when each of the plurality of intervals falls within a range of ±3% of the average value of the plurality of intervals, the plurality of protrusions 24 are considered to be disposed at equal intervals.

The bridge portion 40 includes a plurality of regions 40a, 40b, 40c, and 40d. The bridge portion 40 includes, for example, four regions 40a, 40b, 40c, and 40d.

The region 40a extends to oppose the main surface 3a. The region 40a extends, for example, in a direction substantially perpendicular to the direction D1. The region 40a extends, for example, toward the side surface 13, generally in the direction D2. The bridge portion 40 extends, for example, from the region 20b, generally in the direction D2. The region 40a includes an end closer to the connection portion 20 and an end closer to the region 40b. The region 40a includes a region 40a₁ including the end closer to the connection portion 20 and a region 40a₂ including the end closer to the region 40b. The region 40a has an L-shape as viewed from the direction D1. The L-shape may be a shape that has a substantially L-shape as a whole.

The region 40b is continuous with the region 40a. The region 40b extends to oppose the side surface 3c. The region 40b extends, for example, generally in the direction D4. The region 40c is continuous with the region 40b.

The region 40c extends toward the side surface 13 in a direction intersecting the direction in which the region 40b extends. The region 40c extends, for example, toward the side surface 13, generally in the direction D2. The region 40c is continuous with the mounting portion 30.

The region 40d is continuous with the region 40a. The region 40d connects the region 40a and the connection portion 20. The region 40d extends, for example, generally in the direction D1. The region 40d is continuous with the region 20b. The region 40d is continuous with the one side described above of the two sides defining the corner CR2₁ included in the region 20b. The region 40a is continuous with the region 20b through the region 40d. The region 40a may include a first region included in the bridge portion 40, the region 40b may include a second region included in the bridge portion 40, and the region 40c may include a third region included in the bridge portion 40.

The region 40a is separated from the electrode 5. The region 40a is separated from the electrode 5 more than the region 20b in the direction D1. That is, the bridge portion 40 is separated from the electrode 5 more than the region 20b in the direction D1. The region 40c is separated from the ceramic body 3 (side surface 3c), for example, in the direction D2. The exterior body EB includes a portion located between the region 40a and the electrode 5, and a portion located between the region 40c and the ceramic body 3 (side surface 3c). The region 40a is separated from the electrode 5 by the thickness of the portion of the exterior body EB located between the region 40a and the electrode 5. The region 40c is separated from the ceramic body 3 by the thickness of the portion of the exterior body EB located between the region 40c and the side surface 3c.

The bridge portion 40 has a width W2 smaller than a width W1 including the region 20a and region 20b of the connection portion 20. The width W1 is defined, for example, by a distance between the edge 21c and the edge 21d in the direction D3. The width W2 includes, for example, a width of the region 40a₁ of the region 40a. The width of the region 40a₁ is defined, for example, by the length of the region 40a₁ in the direction D3. The width W1 is, for example, from 3.2 to 4.2 mm, and the width W2 is, for example, from 0.5 to 1.5 mm.

The mounting portion 30 includes a plurality of regions 30a and 30b. The mounting portion 30 includes, for example, two regions 30a and 30b.

The region 30a is along the side surface 13. The region 30a extends, for example, generally in the direction D4. The region 30a extends, for example, generally in the direction D3. The region 30a is continuous with the region 40c. The region 30b extends in a direction intersecting the region 30a. The region 30b extends, for example, generally in the direction D2. The region 30a is provided with a notch 31 close to the boundary with the bridge portion 40 (region 40c). The notch 31 is formed in the region 30a close to the boundary with the bridge portion 40 (region 40c). The region 30b is, for example, along the side surface 11. The region 30b, for example, opposes the side surface 11. The region 30b is, for example, separated from the side surface 11. In a configuration in which the region 30b opposes the side surface 11, the side surface 11 may be provided with a recess 18 at a position corresponding to the region 30b. The region 30a may include a first outer region, and the region 30b may include a second outer region.

As illustrated in FIG. 4, the metal terminal MT2 includes one end located inside the exterior body EB and another end located outside the exterior body EB. The other end of the metal terminal MT2 is exposed from the exterior body EB. As illustrated in FIGS. 9 and 10, the metal terminal MT2 includes a connection portion 50, a mounting portion 60, and a bridge portion 70.

The connection portion 50 is located on the one end side of the metal terminal MT2. The mounting portion 60 is located on the other end side of the metal terminal MT2. The bridge portion 70 bridges the connection portion 50 and the mounting portion 60. The bridge portion 70 is located between the connection portion 50 and the mounting portion 60. The bridge portion 70 is located closer to the side surface 14 than the connection portion 50. For example, the bridge portion 70 is continuous with the connection portion 50 and is continuous with the mounting portion 60. The bridge portion 70 extends from the connection portion 50. The bridge portion 70 extends, for example, from the connection portion 50 toward the side surface 14, generally in the direction D2.

As illustrated in FIG. 3B, the metal terminal MT2 is exposed from the exterior body EB at the side surface 14. The connection portion 50 and the bridge portion 70 are located inside the exterior body EB. The mounting portion 60 is located outside the exterior body EB. For example, the connection portion 20 may include a first connection portion, and the connection portion 50 may include a second connection portion. For example, the mounting portion 30 may include a first mounting portion, and the mounting portion 60 may include a second mounting portion. For example, the bridge portion 40 may include a first bridge portion, and the bridge portion 70 may include a second bridge portion. The connection portion 50 and the bridge portion 70 may include a second inner portion, and the mounting portion 60 may include a second outer portion.

The connection portion 50 is connected to the electrode 7. The connection portion 50 opposes the electrode 7. The connection portion 50 is parallel to the main surface 3b. “Parallel” includes not only completely parallel but also “substantially parallel” as described above. The ratio of the area of the connection portion 50 to the area of the main surface 3b is from 11% to 41%. The area of the main surface 3b is, for example, from 7.05 to 95.05 mm², and the area of the connection portion 50 is, for example, from 5.44 to 22.89 mm².

The connection portion 50 includes a plurality of regions 50a, 50b, and 50c. For example, the connection portion 50 includes three regions 50a, 50b, and 50c. The region 50a opposes the electrode 7. The region 50a is joined to the electrode 7 by the electrically conductive joining material BM. The region 50a is joined to the electrode 7 by surface contact. The region 50b is separated from the electrode 7 and is continuous with the bridge portion 70. The region 50b is not directly joined to the electrode 7. The region 50c is continuous with the region 50a and the region 50b. The region 50b may not be separated from the electrode 7. The region 50b may be in contact with the electrode 7. The region 50a may include a third region included in the connection portion 50, the region 50b may include a fourth region included in the connection portion 50, and the region 50c may include a sixth region included in the connection portion 50.

The connection portion 50 has, for example, a polygonal shape as viewed from the direction D1. The connection portion 50 has, for example, a rectangular shape as viewed from the direction D1. The polygonal shape (rectangular shape) includes, as described above, a shape in which each corner is chamfered or a shape in which each corner is rounded. The connection portion 50 may have a circular shape as viewed from the direction D1. The connection portion 50 may have the same shape as the connection portion 20 as viewed from the direction D1.

The connection portion 50 includes a plurality of edges 51a, 51b, 51c, and 51d. The plurality of edges 51a, 51b, 51c, and 51d define the outer shape of the connection portion 50 as viewed from the direction D1. The connection portion 50 includes, for example, a pair of edges 51a and 51b opposing each other, and a pair of edges 51c and 51d opposing each other. The pair of edges 51a and 51b oppose each other, for example, in a direction in which the bridge portion 70 extends from the connection portion 50. The pair of edges 51c and 51d substantially oppose each other in a direction intersecting the direction in which the pair of edges 51a and 51b oppose each other. The pair of edges 51c and 51d, for example, substantially oppose each other in a direction perpendicular to the direction in which the pair of edges 51a and 51b oppose each other. The pair of edges 51c and 51d, for example, substantially oppose each other in the direction D3. For example, the edge 51a may include a third edge, the edge 51b may include a fourth edge, the edge 51c may include a seventh edge, and the edge 51d may include an eighth edge.

In a configuration in which the connection portion 50 has a polygonal shape as described above, the connection portion 50 includes a plurality of corners as viewed from the direction D1. The connection portion 50 includes, for example, four corners.

The region 50a includes one corner CR1₂ among the plurality of corners included in the connection portion 50. The region 50b includes another corner CR2₂ among the plurality of corners included in the connection portion 50, the other corner CR2₂ being different from the corner CR1₂ included in the region 50a. The corner CR2₂ is adjacent to the corner CR1₂. The region 50c includes a plurality of corners CR3₂ among the plurality of corners included in the connection portion 50, the plurality of corners CR3₂ being different from the two corners CR1₂ and CR2₂ included in the regions 50a and 50b. The region 50c includes, for example, two corners CR3₂. One corner CR3₂ of the plurality of corners CR3₂ is adjacent to the corner CR1₂. Another corner CR3₂ of the plurality of corners CR3₂ is adjacent to the corner CR2₂.

The corner CR1₂ and the two corners CR3₂ are curved as viewed from the direction D1. The corner CR1₂ and the two corners CR3₂ have an arc shape as viewed from the direction D1. The bridge portion 70 is continuous with one of two sides defining the corner CR2₂ included in the region 50b.

An opening OP2 is formed in the region 50a. The opening OP2 penetrates the region 50a. The opening OP2 is located at the center of the main surface 3b as viewed from the direction in which the pair of main surfaces 3a and 3b oppose each other, that is, the direction D1. The opening OP2 is located closer to the corner CR1₂ in the connection portion 50.

The opening OP2 has, for example, a circular shape as viewed from the direction D1. The opening OP2 may have a polygonal shape as viewed from the direction D1. “Center” does not mean only one center point equidistant from all points on the edge of the region 50a that defines the opening OP2. Even at a position separated from the above-described center point, when the distance from the above-described center point includes a minute difference within a predetermined range, a manufacturing error, or a measurement error, it may be regarded as “center”. The predetermined range may be set, for example, in a range of ±3% of the equivalent circle diameter of the opening OP2. The opening OP1 and the opening OP2, for example, have substantially the same shape and have substantially the same size. The opening OP1 and the opening OP2 may have different shapes and may have different sizes.

The region 50a includes a pair of surfaces 52 and 53 opposing each other. The surface 52 opposes the electrode 7. A plurality of protrusions 54 are provided on the surface 52 of the region 50a. For example, three protrusions 54 are formed in the region 50a. A plurality of recesses 55 are provided at positions corresponding to the plurality of protrusions 54 on the surface 53 of the region 50a. The respective tops of the plurality of protrusions 54 are in contact with the electrode 7. The region 50a is in contact with the electrode 7 at the plurality of protrusions 54. The surface 52 and the electrode 7 are in contact with each other at, for example, three locations. The surface 52 is separated from the electrode 7 by the height of the protrusions 54, except for the locations at which the plurality of protrusions 54 are located. The electrically conductive joining material BM that joins the region 50a and the electrode 7 is disposed in a gap between the surface 52 and the electrode 7. This electrically conductive joining material BM is in contact with the surface 52 and the electrode 7. The surface 52 may include a third surface, and the surface 53 may include a fourth surface.

The plurality of protrusions 54 are located along the edge of the opening OP2. The plurality of protrusions 54 are formed along the edge of the opening OP2, except between the edge of the opening OP2 and the corner CR1₂. The plurality of protrusions 54 are located, for example, at equal intervals. “Equal intervals” includes, as described above, for example, that a plurality of intervals are equal to each other, that a difference between the plurality of intervals is within a range of a predetermined minute difference, or that a difference between the plurality of intervals is within a manufacturing error. For example, when each of the plurality of intervals falls within a range of ±3% of the average value of the plurality of intervals, the plurality of protrusions 54 are considered to be disposed at equal intervals.

The bridge portion 70 includes a plurality of regions 70a and 70d. The bridge portion 70 includes, for example, two regions 70a and 70d.

The region 70a extends to oppose the main surface 3b. The region 70a extends, for example, in a direction substantially perpendicular to the direction D1. The region 70a extends, for example, toward the side surface 14, generally in the direction D2. The region 40a and the region 70a extend in opposite directions to each other. The bridge portion 70 extends, for example, from the region 50b, generally in the direction D2. The region 70a includes an end closer to the connection portion 50 and an end closer to the mounting portion 60. The region 70a includes a region 70a₁ including the end closer to the connection portion 50 and a region 70a₂ including the end closer to the mounting portion 60. The region 70a has a T-shape as viewed from the direction D1. The T-shape may be a shape that has a substantially T-shape as a whole. The region 70a may include a fourth region included in the bridge portion 70.

The region 70d is continuous with the region 70a. The region 70d connects the region 70a and the connection portion 50. The region 70d extends, for example, generally in the direction D1. The region 70d is continuous with the region 50b. The region 70d is continuous with the one side described above of the two sides defining the corner CR2₂ included in the region 50b. The region 70a is continuous with the region 50b through the region 70d.

The region 70a is separated from the electrode 7. The region 70a is separated from the electrode 7 more than the region 50b in the direction D1. That is, the bridge portion 70 is separated from the electrode 7 more than the region 50b in the direction D1. The exterior body EB includes a portion located between the region 70a and the electrode 7. The region 70a is separated from the electrode 7 by the thickness of the portion of the exterior body EB located between the region 70a and the electrode 7.

The bridge portion 70 has a width W4 smaller than a width W3 including the region 50a and region 50b of the connection portion 50. The width W3 is defined, for example, by a distance between the edge 51c and the edge 51d in the direction D3. The width W4 includes, for example, a width of the region 70a₁ of the region 70a. The width of the region 70a₁ is defined, for example, by the length of the region 70a₁ in the direction D3. The width W3 is, for example, from 3.2 to 4.2 mm, and the width W4 is, for example, from 0.5 to 1.5 mm.

The mounting portion 60 includes a plurality of regions 60a and 60b. The mounting portion 60 includes, for example, two regions 60a and 60b.

The region 60a is along the side surface 14. The region 60a extends, for example, generally in the direction D4. The region 60a extends, for example, generally in the direction D3. The region 60a is continuous with the region 70a. The region 60b extends in a direction intersecting the region 60a. The region 60a is provided with a notch 61 close to the boundary with the bridge portion 70 (region 70a). The notch 61 is formed in the region 60a close to the boundary with the bridge portion 70 (region 70a). The region 60b extends, for example, generally in the direction D2. The region 60b is, for example, along the side surface 11. The region 60b, for example, opposes the side surface 11. The region 60b is, for example, separated from the side surface 11. In a configuration in which the region 60b opposes the side surface 11, the side surface 11 may be provided with a recess 19 at a position corresponding to the region 60b. The region 60a may include a third outer region, and the region 60b may include a fourth outer region.

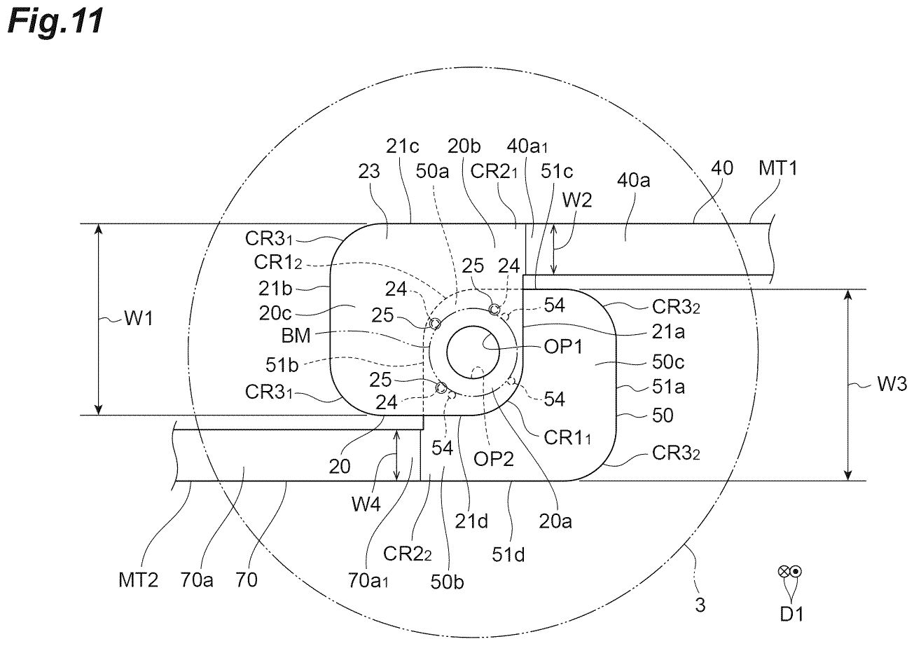

As illustrated in FIG. 11, the connection portion 20 and the connection portion 50 are positioned such that the corner CR1₁ overlaps the connection portion 50 and the corner CR1₂ overlaps the connection portion 20 as viewed from the direction D1. The connection portion 20 and the connection portion 50 are positioned such that the corner CR1₁ and the corner CR1₂ overlap each other in the direction D1. FIG. 11 is a diagram illustrating a pair of metal terminals.

The region 20a and the region 50a overlap each other as viewed from the direction D1. The opening OP1 and the opening OP2 overlap each other as viewed from the direction D1. For example, the opening OP1 and the opening OP2 entirely overlap each other as viewed from the direction D1. The connection portion 20 is connected to the electrode 5 in the region 20a that overlaps the connection portion 50 in the direction D1. The connection portion 50 is connected to the electrode 7 in the region 50a that overlaps the connection portion 20 in the direction D1.

The region 20b and the region 50b are located on opposite sides with the regions 20a and 50a interposed therebetween as viewed from the direction D1. As viewed from the direction D1, the regions 20a and 50a are located between the region 20b and the region 50b. The regions 20a and 50a are, for example, substantially located between the region 20b and the region 50b in the direction D3.

The regions 20b and 20c do not overlap the connection portion 50 in the direction D1. The regions 20b and 20c are exposed from the connection portion 50 as viewed from the direction D1. The corners CR2₁ and CR3₁ are exposed from the connection portion 50 as viewed from the direction D1. The bridge portion 40 is connected to the corner CR2₁ exposed from the connection portion 50.

The regions 50b and 50c do not overlap the connection portion 20 in the direction D1. The regions 50b and 50c are exposed from the connection portion 20 as viewed from the direction D1. The corners CR2₂ and CR3₂ are exposed from the connection portion 20 as viewed from the direction D1. The bridge portion 70 is connected to the corner CR2₂ exposed from the connection portion 20.

The corner CR2₁ and the corner CR2₂ are located on opposite sides with the regions 20a and 50a interposed therebetween as viewed from the direction D1. As viewed from the direction D1, the regions 20a and 50a are located between the corner CR2₁ and the corner CR2₂. The regions 20a and 50a are, for example, substantially located between the corner CR2₁ and the corner CR2₂ in the direction D3.

The connection portion 20 and the connection portion 50 are positioned such that the edge 21a overlaps the connection portion 50 and the edge 51b overlaps the connection portion 20 as viewed from the direction D1.

In a view of the connection portion 20 and the connection portion 50 from the direction D1, the ratio of the distance between the edge 21a and the edge 51b to each of the distance between the edge 21a and the edge 21b and the distance between the edge 51a and the edge 51b is, for example, from 48% to 52%. The distance between the edge 21a and the edge 21b is, for example, from 1.7 to 5.45 mm. The distance between the edge 51a and the edge 51b is, for example, from 1.7 to 5.45 mm. The distance between the edge 21a and the edge 51b is, for example, from 1.7 to 2.81 mm. The distance between the edge 21a and the edge 21b is defined, for example, by the shortest distance between the edge 21a and the edge 21b. The distance between the edge 51a and the edge 51b is defined, for example, by the shortest distance between the edge 51a and the edge 51b. The distance between the edge 21a and the edge 51b is defined, for example, by the shortest distance between the edge 21a and the edge 51b. Each of the above-described distances may be defined by a maximum distance or an average distance instead of the shortest distance.

The connection portion 20 and the connection portion 50 are positioned such that the edge 21d overlaps the connection portion 50 and the edge 51c overlaps the connection portion 20 as viewed from the direction D1.

In a view of the connection portion 20 and the connection portion 50 from the direction D1, the ratio of the distance between the edge 21d and the edge 51c to each of the distance between the edge 21c and the edge 21d and the distance between the edge 51c and the edge 51d is, for example, from 57% to 72%. The distance between the edge 21c and the edge 21d is, for example, from 3.2 to 4.2 mm. The distance between the edge 51c and the edge 51d is, for example, from 3.2 to 4.2 mm. The distance between the edge 21d and the edge 51c is, for example, from 1.4 to 3.4 mm. The distance between the edge 21c and the edge 21d is defined, for example, by the shortest distance between the edge 21c and the edge 21d. The distance between the edge 51c and the edge 51d is defined, for example, by the shortest distance between the edge 51c and the edge 51d. The distance between the edge 21d and the edge 51c is defined, for example, by the shortest distance between the edge 21d and the edge 51c. Each of the above-described distances may be defined by a maximum distance or an average distance instead of the shortest distance.

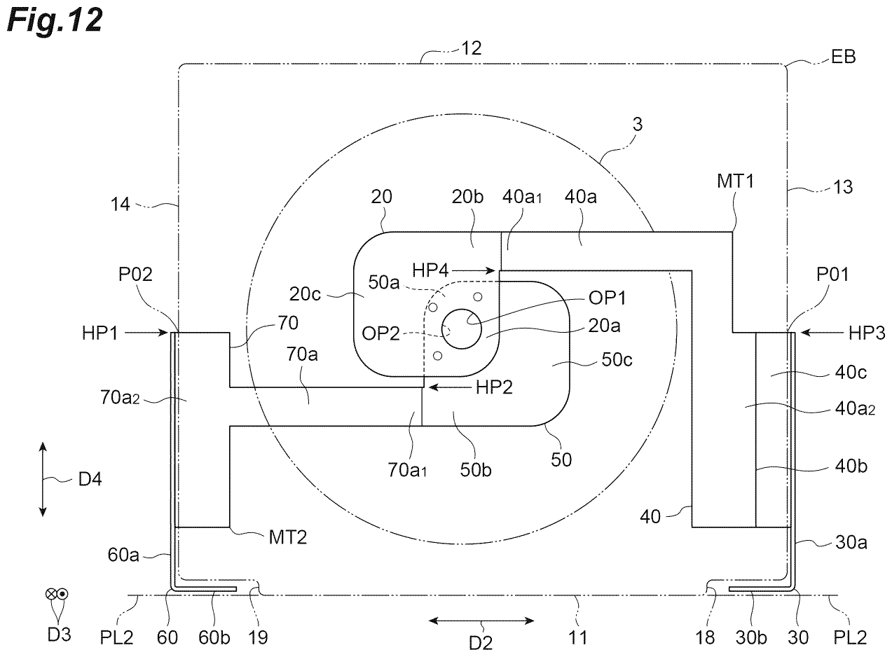

As illustrated in FIG. 12, in a direction perpendicular to the side surface 11, a height position HP1 of an end of the mounting portion 60 closer to the side surface 12 is higher than a height position HP2 of a position at which the connection portion 50 and the bridge portion 70 are connected to each other. The direction perpendicular to the side surface 11 includes, for example, the direction D4. The reference for the height position HP1 is a plane PL2 including the side surface 11. For example, in the direction perpendicular to the side surface 11, a distance between the plane PL2 and the end of the mounting portion 60 closer to the side surface 12 is larger than a distance between the plane PL2 and an end of the region 70a₁ closer to the side surface 12. FIG. 12 is a diagram illustrating a pair of metal terminals. The height position HP1 may include a first height position, and the height position HP2 may include a second height position.

In the direction perpendicular to the side surface 11, a height position HP3 of an end of the mounting portion 30 closer to the side surface 12 is lower than a height position HP4 of a position at which the connection portion 20 and the bridge portion 40 are connected to each other. For example, in the direction perpendicular to the side surface 11, a distance between the plane PL2 and the end of the mounting portion 30 closer to the side surface 12 is smaller than a distance between the plane PL2 and an end of the region 40a₁ closer to the side surface 11. The height position HP3 may include a third height position, and the height position HP4 may include a fourth height position.

In the direction perpendicular to the side surface 11, the height position HP1 and the height position HP3 are between the height position HP2 and the height position HP4. In the direction perpendicular to the side surface 11, the height position HP2 is lower than the height position HP4.

For example, the height position HP1 and the height position HP3 are the same. For example, in the direction perpendicular to the side surface 11, the distance between the plane PL2 and the end of the mounting portion 60 closer to the side surface 12 and the distance between the plane PL2 and the end of the mounting portion 30 closer to the side surface 12 are the same. For example, in the direction perpendicular to the side surface 11, a distance between the plane PL2 and an end of the mounting portion 60 closer to the side surface 11 and a distance between the plane PL2 and an end of the mounting portion 30 closer to the side surface 11 are the same. That a plurality of values are the same includes, for example, that the plurality of values are equal to each other, that a difference between the plurality of values is within a range of a predetermined minute difference, that a difference between the plurality of values is within a manufacturing error, or that a difference between the plurality of values is within a measurement error. For example, when each of the plurality of values falls within a range of ±3% of the average value of the plurality of values, the plurality of values are considered to be the same.

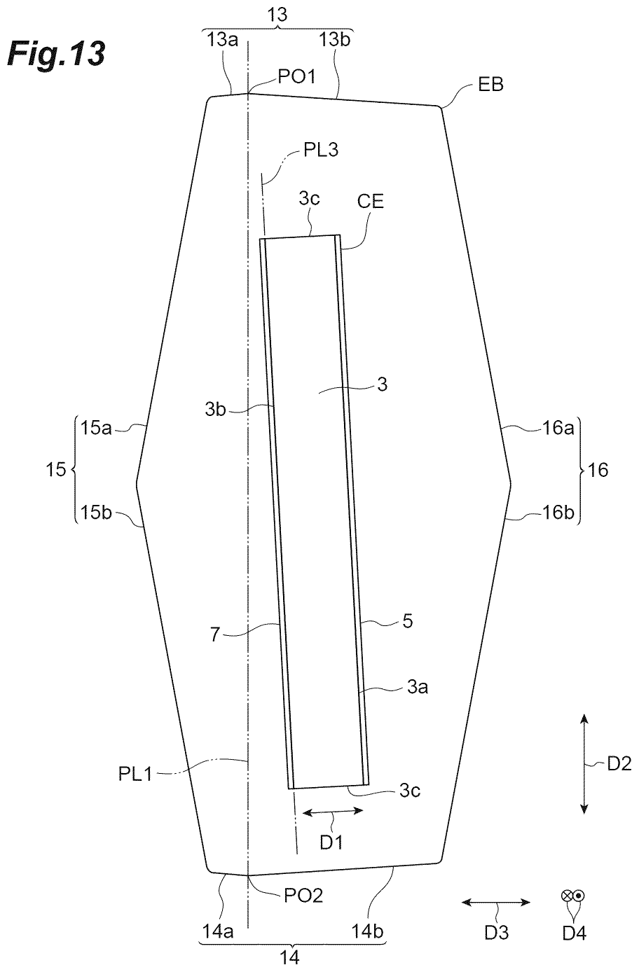

As illustrated in FIG. 13, the ceramic body 3 is located on one side of a plane PL1. The plane PL1 is, for example, perpendicular to the side surface 11 and the side surface 12. The plane PL1 includes a position PO1 on the side surface 13 at which the metal terminal MT1 is exposed, and a position PO2 on the side surface 14 at which the metal terminal MT2 is exposed. The ceramic body 3 is located closer to the side surface 16 than the position PO1 and the position PO2 in the direction D3. The side surface 15 opposes, for example, the ceramic body 3 (main surface 3b) in a direction perpendicular to the plane PL1. The side surface 16 opposes, for example, the ceramic body 3 (main surface 3a) in the direction perpendicular to the plane PL1. The plane PL1 is, for example, substantially perpendicular to the direction D3 and substantially parallel to the directions D2 and D4. FIG. 13 is a schematic diagram illustrating a configuration of a ceramic element and an exterior body.

The mounting portion 30 is located closer to the side surface 15 than the position PO1 in the direction D3. Therefore, the ceramic body 3 and the mounting portion 30 are configured such that the ceramic body 3 and the mounting portion 30 overlap each other in a view from a side of the side surface 13 in a direction parallel to the side surface 11 and the plane PL1, as illustrated in FIG. 3A. The connection portion 20 opposes the electrode 5 in the direction D1. Therefore, the ceramic body 3 and the connection portion 20 are configured such that the ceramic body 3 and the connection portion 20 do not overlap each other in a view from a side of the side surface 13 in a direction parallel to the side surface 11 and the plane PL1. The bridge portion 40 opposes the side surface 3c in the direction D2. Therefore, the ceramic body 3 and the bridge portion 40 are configured such that, for example, the ceramic body 3 and the region 40b overlap each other in a view from a side of the side surface 13 in a direction parallel to the side surface 11 and the plane PL1. The direction parallel to the side surface 11 and the plane PL1 includes, for example, the direction D2.

The mounting portion 60 is located closer to the side surface 16 than the position PO2 in the direction D3. Therefore, the ceramic body 3 and the mounting portion 60 are configured such that the ceramic body 3 and the mounting portion 60 overlap each other in a view from a side of the side surface 14 in a direction parallel to the side surface 11 and the plane PL1, as illustrated in FIG. 3B. The connection portion 50 opposes the electrode 7 in the direction D1, and the bridge portion 70 does not oppose the side surface 3c in the direction D2. Therefore, the ceramic body 3 and the connection portion 50 and bridge portion 70 are configured such that the ceramic body 3 and the connection portion 50 and bridge portion 70 do not overlap each other in a view from a side of the side surface 14 in a direction parallel to the side surface 11 and the plane PL1.

In the direction perpendicular to the plane PL1, a distance between the side surface 16 and the ceramic body 3 is larger than a distance between the side surface 15 and the ceramic body 3. The distance between the side surface 16 and the ceramic body 3 is, for example, from 2.5 to 4.5 mm. The distance between the side surface 15 and the ceramic body 3 is, for example, from 2.1 to 3.6 mm. The distance between the side surface 16 and the ceramic body 3 is defined, for example, by the shortest distance between the side surface 16 and the ceramic body 3. The distance between the side surface 15 and the ceramic body 3 is defined, for example, by the shortest distance between the side surface 15 and the ceramic body 3. Each of the above-described distances may be defined by a maximum distance or an average distance instead of the shortest distance.

The side surface 13 includes a plurality of surface regions 13a and 13b. For example, the side surface 13 includes two surface regions 13a and 13b. The surface region 13a is located closer to the side surface 15 than the plane PL1. The surface region 13b is located closer to the side surface 16 than the plane PL1. The region 30a is along the surface region 13b.

The side surface 14 includes a plurality of surface regions 14a and 14b. For example, the side surface 14 includes two surface regions 14a and 14b. The surface region 14a is located closer to the side surface 15 than the plane PL1. The surface region 14b is located closer to the side surface 16 than the plane PL1. The region 60a is along the surface region 14b. Each of the surface regions 13a and 14a may include a first surface region, and each of the surface regions 13b and 14b may include a second surface region.

The surface regions 13a and 14a are inclined such that a distance between the surface regions 13a and 14a decreases with increasing distance from the plane PL1. The surface regions 13b and 14b are inclined such that a distance between the surface regions 13b and 14b decreases with increasing distance from the plane PL1. An angle formed by the plane PL1 and the surface region 13a is, for example, from 85 to 87°. An angle formed by the plane PL1 and the surface region 13b is, for example, from 85 to 87°. An angle formed by the plane PL1 and the surface region 14a is, for example, from 85 to 87°. An angle formed by the plane PL1 and the surface region 14b is, for example, from 85 to 87°.

The side surface 15 includes a plurality of surface regions 15a and 15b. For example, the side surface 15 includes two surface regions 15a and 15b. The surface region 15a is located closer to the side surface 13. The surface region 15b is located closer to the side surface 14. The side surface 16 includes a plurality of surface regions 16a and 16b. For example, the side surface 16 includes two surface regions 16a and 16b. The surface region 16a is located closer to the side surface 13. The surface region 16b is located closer to the side surface 14.

The surface regions 15a and 16a are inclined such that a distance between the surface regions 15a and 16a decreases with decreasing distance to the side surface 13. The surface regions 15b and 16b are inclined such that a distance between the surface regions 15b and 16b decreases with decreasing distance to the side surface 14. An angle formed by the surface region 15a and the surface region 13a is, for example, from 103 to 105°. An angle formed by the surface region 15b and the surface region 14a is, for example, from 103 to 105°. An angle formed by the surface region 16a and the surface region 13b is, for example, from 103 to 105°. An angle formed by the surface region 16b and the surface region 14b is, for example, from 103 to 105°.

The ceramic body 3 is located closer to the side surface 16 than the plane PL1.

In the direction perpendicular to the plane PL1, a distance between the plane PL1 and the side surface 16 is larger than a distance between the plane PL1 and the side surface 15. The distance between the plane PL1 and the side surface 16 is, for example, from 3.22 to 6.22 mm. The distance between the plane PL1 and the side surface 15 is, for example, from 1.66 to 3.16 mm. The distance between the plane PL1 and the side surface 16 is defined, for example, by the shortest distance between the plane PL1 and the side surface 16. The distance between the plane PL1 and the side surface 15 is defined, for example, by the shortest distance between the plane PL1 and the side surface 15. Each of the above-described distances may be defined by a maximum distance or an average distance instead of the shortest distance.

The ceramic body 3 is sandwiched by the pair of metal terminals MT1 and MT2. The connection portion 20 and the bridge portion 40 of the metal terminal MT1 are located closer to the side surface 16 than the connection portion 50 and the bridge portion 70 of the metal terminal MT2. The connection portion 50 and the bridge portion 70 of the metal terminal MT2 are located closer to the side surface 15 than the connection portion 20 and the bridge portion 40 of the metal terminal MT1. The ceramic body 3 is inclined to be separated from the plane PL1, from an end side of the ceramic body 3 closer to the side surface 13 toward an end side of the ceramic body 3 closer to the side surface 14. That is, the ceramic body 3 is inclined such that an end of the ceramic body 3 closer to the side surface 14 is separated from the side surface 15 and an end of the ceramic body 3 closer to the side surface 13 is separated from the side surface 16. For example, an angle formed by the plane PL1 and a plane PL3 including the main surface 3b is larger than 0° and 3° or less.

As will be described below, the electronic component EC1, for example, can provide certain technical benefits.

The electronic component EC1 is mounted on an electronic device such that the side surface 11 opposes the electronic device.

In the electronic component EC1, a portion of the metal terminal MT1 exposed from the exterior body EB, including the mounting portion 30, tends to contribute to the fixing strength of the electronic component EC1 to the electronic device. Similarly, a portion of the metal terminal MT2 exposed from the exterior body EB, including the mounting portion 60, tends to contribute to the fixing strength of the electronic component EC1 to the electronic device. The metal terminal MT1 is exposed from the exterior body EB at the side surface 13, and the metal terminal MT2 is exposed from the exterior body EB at the side surface 14. Therefore, the electronic component EC1 can increase the size of a portion contributing to the fixing strength, as compared to a configuration in which the metal terminal MT1 and the metal terminal MT2 are exposed from the exterior body EB at the mounting surface.

In the electronic component EC1, the ceramic body 3 is located on the one side of the plane PL1, and the ceramic body 3 and the mounting portion 30 are configured such that the ceramic body 3 and the mounting portion 30 overlap each other in a view from a side of the side surface 13 in the direction parallel to the side surface 11 and the plane PL1, and the ceramic body 3 and the mounting portion 60 are configured such that the ceramic body 3 and the mounting portion 60 overlap each other in a view from a side of the side surface 14 in the direction parallel to the side surface 11 and the plane PL1. Therefore, the electronic component EC1 can increase the size of each of the mounting portion 30 and the mounting portion 60.

Consequently, the electronic component EC1 can increase the fixing strength to the electronic device.

The ceramic body 3 and the bridge portion 40 may be configured such that the ceramic body 3 and the bridge portion 40 overlap each other in a view from a side of the side surface 13 in the direction parallel to the side surface 11 and the plane PL1. The ceramic body 3 and the bridge portion 70 may be configured such that the ceramic body 3 and the bridge portion 70 do not overlap each other in a view from a side of the side surface 14 in the direction parallel to the side surface 11 and the plane PL1.

In a configuration in which the ceramic body 3 and the bridge portion 40 overlap each other as described above and the ceramic body 3 and the bridge portion 70 do not overlap each other as described above, this configuration can reliably increase the fixing strength to the electronic device.

In the direction perpendicular to the plane PL1, the distance between the side surface 16 and the ceramic body 3 may be larger than the distance between the side surface 15 and the ceramic body 3.

In a configuration in which the distance between the side surface 16 and the ceramic body 3 is larger than the distance between the side surface 15 and the ceramic body 3 as described above, this configuration can further increase the fixing strength to the electronic device.

The electronic component EC1 may include the connection portion 20 and the bridge portion 40. The electronic component EC1 may include the connection portion 50 and the bridge portion 70. The bridge portion 40 may include the regions 40a, 40b, and 40c. The bridge portion 70 may include the region 70a.

In a configuration including the connection portion 20 and the bridge portion 40 including the regions 40a, 40b, and 40c, and including the connection portion 50 and the bridge portion 70 including the region 70a, this configuration stably supports the ceramic body 3 located on the one side of the plane PL1.

The connection portion 20 and the connection portion 50 may have a rectangular shape as viewed from the direction in which the main surface 3a and the main surface 3b oppose each other, that is, the direction D1, and may be located such that the corner CR1₁ and the corner CR1₂ overlap each other in the direction D1. The bridge portion 40 may be connected to the corner CR2₁. The bridge portion 70 may be connected to the corner CR2₂.

In a configuration in which the connection portion 20 and the connection portion 50 are located as described above, and the bridge portion 40 is connected to the corner CR2₁, and the bridge portion 70 is connected to the corner CR2₂, the ceramic body 3 can be stably supported by the metal terminal MT1 (connection portion 20) and the metal terminal MT2 (connection portion 50).

The region 40a may include the region 40a₁ and the region 40a₂, and may have an L-shape as viewed from the direction D1. The region 70a may include the region 70a₁ and the region 70a₂, and may have a T-shape as viewed from the direction D1.

In a configuration in which the region 40a has an L-shape as described above and the region 70a has a T-shape as described above, the bridge portion 40 and the bridge portion 70 can have an elastic force. The elastic force that the bridge portion 40 has can generate a force toward the ceramic body 3 on the connection portion 20. The elastic force that the bridge portion 70 has can generate a force toward the ceramic body 3 on the connection portion 50. Therefore, the ceramic body 3 can be supported more stably.

The connection portion 20 may be connected to the electrode 5 in a region overlapping the connection portion 50 in the direction D1. The connection portion 50 may be connected to the electrode 7 in a region overlapping the connection portion 20 in the direction D1.

In a configuration in which the connection portion 20 is connected to the electrode 5 as described above and the connection portion 50 is connected to the electrode 7 as described above, a region in which the connection portion 20 and the electrode 5 are connected and a region in which the connection portion 50 and the electrode 7 are connected can overlap in the direction D1. Therefore, in this configuration, the ceramic body 3 can be more stably supported by the metal terminal MT1 and the metal terminal MT2.

The corner CR2₁ of the connection portion 20 and the corner CR2₂ of the connection portion 50 may be located on opposite sides with a region in which the connection portion 20 and the connection portion 50 overlap each other interposed therebetween, as viewed from the direction D1.

In a configuration in which the corner CR2₁ of the connection portion 20 and the corner CR2₂ of the connection portion 50 are located as described above, the ceramic body 3 can be more stably supported by the metal terminal MT1 and the metal terminal MT2.

The region 40a may be separated from the electrode 5. The region 70a may be separated from the electrode 7.

In a configuration in which the region 40a is separated from the electrode 5 and the region 70a is separated from the electrode 7, this configuration suppresses the occurrence of an unintended short circuit between the electrode 5 and the electrode 7.

For example, in a configuration in which the metal terminals MT1 and MT2 include a plating film, when the electronic component EC1 is solder-mounted, a metal material included in the plating film of the regions 40a and 70a may melt and adhere to the ceramic body 3 so as to short-circuit the electrode 5 and the electrode 7.

In contrast, in a configuration in which the region 40a is separated from the electrode 5, a part of the exterior body EB tends to exist between the region 40a and the electrode 5, and in a configuration in which the region 70a is separated from the electrode 7, a part of the exterior body EB tends to exist between the region 70a and the electrode 7. Therefore, even when the metal material included in the plating film of the regions 40a and 70a melts, these configurations prevent the molten metal material from adhering to the ceramic body 3.

The surface regions 13a and 14a may be inclined such that a distance between the surface regions 13a and 14a decreases with increasing distance from the plane PL1. The surface regions 13b and 14b may be inclined such that a distance between the surface regions 13b and 14b decreases with increasing distance from the plane PL1.

In a configuration in which the surface regions 13a and 14a are inclined as described above, and the surface regions 13b and 14b are inclined as described above, this configuration can reduce the volume of the exterior body EB as compared to a configuration in which the surface regions 13a and 14a are not inclined as described above, and the surface regions 13b and 14b are not inclined as described above. The reduction in the volume of the exterior body EB leads to a reduction in the weight of the electronic component EC1. For example, the amount of resin included in the exterior body EB is reduced, and the mass of the electronic component EC1 is reduced. Therefore, stress generated by vibration of the electronic component EC1 can be relaxed.

The ceramic body 3 may be located closer to the side surface 16 than the plane PL1.

In a configuration in which the ceramic body 3 is located closer to the side surface 16 than the plane PL1, this configuration reliably realizes a configuration in which the ceramic body 3 is located on the one side of the plane PL1.

In the direction perpendicular to the plane PL1, a distance between the plane PL1 and the side surface 16 may be larger than a distance between the plane PL1 and the side surface 15.

In a configuration in which the distance between the plane PL1 and the side surface 16 is larger than the distance between the plane PL1 and the side surface 15 as described above, this configuration can further increase the size of each of the mounting portion 30 and the mounting portion 60. Therefore, this configuration can further increase the fixing strength to the electronic device.

The mounting portion 30 may include the region 30a, and the mounting portion 60 may include the region 60a.

In a configuration in which the mounting portion 30 includes the region 30a and the mounting portion 60 includes the region 60a, the electronic component EC1 is reliably mounted on the electronic device.

The surface regions 15a and 16a may be inclined relative to the plane PL1 such that a distance between the surface regions 15a and 16a decreases with decreasing distance to the side surface 13. The surface regions 15b and 16b may be inclined relative to the plane PL1 such that a distance between the surface regions 15b and 16b decreases with decreasing distance to the side surface 14.

In a configuration in which the surface regions 15a and 16a are inclined as described above, and the surface regions 15b and 16b are inclined as described above, the electronic component EC1 tends not to fall in the direction perpendicular to the plane PL1. Therefore, this configuration improves the vibration resistance of the electronic component EC1.

The mounting portion 30 may include the region 30a along the side surface 13 and the region 30b extending in a direction intersecting the region 30a. The mounting portion 60 may include the region 60a along the side surface 14 and the region 60b extending in a direction intersecting the region 60a.

In a configuration in which the mounting portion 30 includes the region 30a and the region 30b, and the mounting portion 60 includes the region 60a and the region 60b, the electronic component EC1 is reliably mounted on the electronic device.

The regions 30b and 60b may be along the side surface 11. The side surface 11 may be provided with the recess 18 at a position corresponding to the region 30b, and may be provided with the recess 19 at a position corresponding to the region 60b.

In a configuration in which the recesses 18 and 19 are provided in the side surface 11 as described above, for example, when forming the regions 30b and 60b by bending, bending can be performed in consideration of the springback of each of the regions 30b and 60b.

A configuration in which the recesses 18 and 19 are not provided in the side surface 11 increases the height of the electronic component EC1 in a direction perpendicular to the side surface 11 by the thickness of each of the regions 30b and 60b. In contrast, a configuration in which the recesses 18 and 19 are provided in the side surface 11 as described above can suppress an increase in the height of the electronic component EC1 in the direction perpendicular to the side surface 11.

As will be described below, the electronic component EC1, for example, can provide certain other technical benefits.

The electronic component EC1 is mounted on an electronic device such that the side surface 11 opposes the electronic device.

In the electronic component EC1, a portion of the metal terminal MT1 exposed from the exterior body EB, including the mounting portion 30, tends to contribute to the fixing strength of the electronic component EC1 to the electronic device. Similarly, a portion of the metal terminal MT2 exposed from the exterior body EB, including the mounting portion 60, tends to contribute to the fixing strength of the electronic component EC1 to the electronic device. The metal terminal MT1 is exposed from the exterior body EB at the side surface 13, and the metal terminal MT2 is exposed from the exterior body EB at the side surface 14. Therefore, the electronic component EC1 can increase the size of a portion contributing to the fixing strength, as compared to a configuration in which the metal terminal MT1 and the metal terminal MT2 are exposed from the exterior body EB at the mounting surface.

In the electronic component EC1, in the direction perpendicular to the side surface 11, the height position HP1 is higher than the height position HP2. Therefore, the electronic component EC1 can increase the size of the mounting portion 60 in the direction perpendicular to the side surface 11.

Consequently, the electronic component EC1 can increase the fixing strength to the electronic device.

In the direction perpendicular to the side surface 11, the height position HP3 may be lower than the height position HP4.

In a configuration in which the height position HP3 is lower than the height position HP4 in the direction perpendicular to the side surface 11, the size of the mounting portion 30 in the direction perpendicular to the side surface 11 tends to match the size of the mounting portion 60 in the direction perpendicular to the side surface 11. Therefore, this configuration can stabilize the posture of the electronic component EC1 during mounting.

In the direction perpendicular to the side surface 11, the height position HP1 and the height position HP3 may be between the height position HP2 and the height position HP4.

An increase in the size of the portion contributing to the fixing strength results in an increase in the fixing strength of the electronic component. In this case, when stress acts on the electronic component from the electronic device, for example, the adhesion between the metal terminal and the exterior body may be reduced. When the adhesion between the metal terminal and the exterior body is reduced, for example, peeling may occur between the metal terminal and the exterior body. Peeling between the metal terminal and the exterior body may reduce the reliability of the electronic component.

In contrast, in a configuration in which the height position HP1 and the height position HP3 are between the height position HP2 and the height position HP4 in the direction perpendicular to the side surface 11, the size of each of the mounting portion 30 and the mounting portion 60 in the direction perpendicular to the side surface 11 tends not to excessively increase. Therefore, this configuration can suppress an excessive increase in the fixing strength.

In the direction perpendicular to the side surface 11, the height position HP2 may be lower than the height position HP4.

In a configuration in which the height position HP2 is lower than the height position HP4 in the direction perpendicular to the side surface 11, the size of the mounting portion 30 in the direction perpendicular to the side surface 11 tends to more closely match the size of the mounting portion 60 in the direction perpendicular to the side surface 11.

The bridge portion 70 may include a region 70a extending to oppose the main surface 3b and having a T-shape as viewed from the direction in which the main surface 3a and the main surface 3b oppose each other.

In a configuration in which the bridge portion 70 includes the region 70a having a T-shape as described above, the region 70a can have an elastic force. The elastic force that the region 70a has can generate a force toward the ceramic body 3 on the connection portion 50. Therefore, the ceramic body 3 can be stably supported.

The region 70a included in the bridge portion 70 may be separated from the electrode 7. The bridge portion 70 may include a region 70d connecting the region 70a and the connection portion 50.

A configuration in which the region 70a is separated from the electrode 7 suppresses the occurrence of an unintended short circuit between the electrode 7 and the electrode 5.

For example, in a configuration in which the metal terminal MT2 include a plating film, when the electronic component EC1 is solder-mounted, a metal material included in the plating film of the region 70a may melt and adhere to the ceramic body 3 so as to short-circuit the electrode 7 and the electrode 5.

In contrast, in a configuration in which the region 70a is separated from the electrode 7, a part of the exterior body EB tends to exist between the region 70a and the electrode 7. Therefore, even when the metal material included in the plating film of the region 70a melts, this configuration prevents the molten metal material from adhering to the ceramic body 3.

The bridge portion 40 may include a region 40a extending to oppose the main surface 3a and having an L-shape as viewed from the direction in which the main surface 3a and the main surface 3b oppose each other, a region 40b continuous with the region 40a and extending to oppose the side surface 3c, and a region 40c continuous with the region 40b and extending toward the side surface 13 in a direction intersecting a direction in which the region 40b extends.

In a configuration in which the bridge portion 40 includes the region 40a having an L-shape and the regions 40b and 40c as described above, the region 40a can have an elastic force. The elastic force that the region 40a has can generate a force toward the ceramic body 3 on the connection portion 20. Therefore, the ceramic body 3 can be stably supported.

The region 40a may be separated from the electrode 5. The bridge portion 40 may include a region 40d connecting the region 40a and the connection portion 20.

A configuration in which the region 40a is separated from the electrode 5 suppresses the occurrence of an unintended short circuit between the electrode 5 and the electrode 7.

For example, in a configuration in which the metal terminal MT1 includes a plating film, when the electronic component EC1 is solder-mounted, a metal material included in the plating film of the bridge portion 40 may melt and adhere to the ceramic body 3 so as to short-circuit the electrode 5 and the electrode 7.

In contrast, in a configuration in which the region 40a is separated from the electrode 5, a part of the exterior body EB tends to exist between the region 40a and the electrode 5. Therefore, even when the metal material included in the plating film of the bridge portion 40 melts, this configuration prevents the molten metal material from adhering to the ceramic body 3.

The connection portion 20 and the connection portion 50 may have a rectangular shape as viewed from the direction in which the main surface 3a and the main surface 3b oppose each other, that is, the direction D1, and may be located such that the corner CR1₁ and the corner CR1₂ overlap each other in the direction D1. The bridge portion 40 may be connected to the corner CR2₁. The bridge portion 70 may be connected to the corner CR2₂.

In a configuration in which the connection portion 20 and the connection portion 50 are located as described above, the bridge portion 40 is connected to the corner CR2₁, and the bridge portion 70 is connected to the corner CR2₂, the ceramic body 3 can be stably supported by the metal terminal MT1 (connection portion 20) and the metal terminal MT2 (connection portion 50).

The connection portion 20 may be connected to the electrode 5 in a region overlapping the connection portion 50 in the direction D1. The connection portion 50 may be connected to the electrode 7 in a region overlapping the connection portion 20 in the direction D1.

In a configuration in which the connection portion 20 is connected to the electrode 5 as described above and the connection portion 50 is connected to the electrode 7 as described above, a region in which the connection portion 20 and the electrode 5 are connected and a region in which the connection portion 50 and the electrode 7 are connected can overlap in the direction D1. Therefore, in this configuration, the ceramic body 3 can be more stably supported by the metal terminal MT1 and the metal terminal MT2.

The corner CR2₁ of the connection portion 20 and the corner CR2₂ of the connection portion 50 may be located on opposite sides with a region in which the connection portion 20 and the connection portion 50 overlap each other interposed therebetween, as viewed from the direction D1.

In a configuration in which the corner CR2₁ of the connection portion 20 and the corner CR2₂ of the connection portion 50 are located as described above, the ceramic body 3 can be more stably supported by the metal terminal MT1 and the metal terminal MT2.

The exterior body EB may include the side surface 15 and the side surface 16 that are adjacent to the side surface 11, the side surface 13, and the side surface 14 and oppose each other. The ceramic body 3 may be located closer to the side surface 16 than the plane PL1 such that the main surface 3b opposes the side surface 15 and the main surface 3a opposes the side surface 16.

A configuration in which the ceramic body 3 is located as described above can increase the size of each of the mounting portion 30 and the mounting portion 60. Therefore, this configuration can increase the fixing strength to the electronic device.

The ceramic body 3 and the mounting portion 30 may be configured such that the ceramic body 3 and the mounting portion 30 overlap each other in a view from a side of the side surface 13 in the direction parallel to the side surface 11 and the plane PL1. The ceramic body 3 and the mounting portion 60 may be configured such that the ceramic body 3 and the mounting portion 60 overlap each other in a view from a side of the side surface 14 in the direction parallel to the side surface 11 and the plane PL1.

In a configuration in which the ceramic body 3 and the mounting portion 30 overlap each other as described above and the ceramic body 3 and the mounting portion 60 overlap each other as described above, this configuration can reliably increase the size of each of the mounting portion 30 and the mounting portion 60. Therefore, this configuration can reliably increase the fixing strength to the electronic device.

In the direction perpendicular to the plane PL1, a distance between the plane PL1 and the side surface 16 may be larger than a distance between the plane PL1 and the side surface 15.

In a configuration in which the distance between the plane PL1 and the side surface 16 is larger than the distance between the plane PL1 and the side surface 15, this configuration can further increase the size of each of the mounting portion 30 and the mounting portion 60. Therefore, this configuration can further increase the fixing strength to the electronic device.

The ceramic body 3 and the bridge portion 40 may be configured such that the ceramic body 3 and the bridge portion 40 overlap each other in a view from a side of the side surface 13 in the direction parallel to the side surface 11 and the plane PL1. The ceramic body 3 and the bridge portion 70 may be configured such that the ceramic body 3 and the bridge portion 70 do not overlap each other in a view from a side of the side surface 14 in the direction parallel to the side surface 11 and the plane PL1.

In a configuration in which the ceramic body 3 and the bridge portion 40 overlap each other as described above and the ceramic body 3 and the bridge portion 70 do not overlap each other as described above, this configuration can reliably increase the fixing strength to the electronic device.

The mounting portion 30 may include the region 30a extending from the position PO1 along the side surface 13. The mounting portion 60 may include the region 60a extending from the position PO2 along the side surface 14.

In a configuration in which the mounting portion 30 includes the region 30a and the mounting portion 60 includes the region 60a, the electronic component EC1 is reliably mounted on the electronic device.

The mounting portion 30 may include the region 30a along the side surface 13. The mounting portion 60 may include the region 60a along the side surface 14. The region 30a may be provided with the notch 31 close to the boundary with the bridge portion 40. The region 60a may be provided with the notch 61 close to the boundary with the bridge portion 70.

A process of obtaining the region 30a includes, for example, bending. In a configuration provided with the notch 31 as described above, the region 30a is reliably obtained by bending. A process of obtaining the region 60a includes, for example, bending. In a configuration provided with the notch 61 as described above, the region 60a is reliably obtained by bending.

As will be described below, the electronic component EC1, for example, can provide certain further technical benefits.

In the electronic component EC1, the electrode 5 is joined to the region 20a of the connection portion 20 by surface contact. The electrode 7 is joined to the region 50a of the connection portion 50 by surface contact. The ceramic body 3 is sandwiched by the metal terminals MT1 and MT2. In a state in which the ceramic body 3 is sandwiched by the metal terminals MT1 and MT2, a biasing force from the metal terminal MT1 toward the ceramic body 3 and a biasing force from the metal terminal MT2 toward the ceramic body 3 are generated. The biasing force from the metal terminal MT1 toward the ceramic body 3 acts on the main surface 3a of the ceramic body 3 through a surface on which the region 20a and the electrode 5 are joined. The biasing force from the metal terminal MT2 toward the ceramic body 3 acts on the main surface 3b of the ceramic body 3 through a surface on which the region 50a and the electrode 7 are joined. The ceramic body 3 is inclined such that an end of the ceramic body 3 closer to the side surface 14 is separated from the side surface 15, and an end of the ceramic body 3 closer to the side surface 13 is separated from the side surface 16. In a state in which the ceramic body 3 is sandwiched by the metal terminals MT1 and MT2 and is inclined as described above, the biasing force from the metal terminal MT1 toward the ceramic body 3 and the biasing force from the metal terminal MT2 toward the ceramic body 3 tend to be balanced. Therefore, the electronic component EC1 can stably support the ceramic body 3.

The side surface 11 may be arranged to constitute a mounting surface. The ceramic body 3 may be inclined to be separated from the plane PL1 from an end side of the ceramic body 3 closer to the side surface 13 toward an end side of the ceramic body 3 closer to the side surface 14.

In a configuration in which the ceramic body 3 is inclined to be separated from the plane PL1 from the end side of the ceramic body 3 closer to the side surface 13 toward the end side of the ceramic body 3 closer to the side surface 14, this configuration can stably support the ceramic body 3 even in a configuration in which the side surface 11 is arranged to constitute a mounting surface.

An angle formed by the plane PL1 and the plane PL3 including the main surface 3b may be larger than 0° and 3° or less.

In a configuration in which the angle formed by the plane PL1 and the plane PL3 is larger than 0° and 3° or less, this configuration can reliably and stably support the ceramic body 3.

The connection portion 20 may be parallel to the main surface 3a, and the connection portion 50 may be parallel to the main surface 3b.

In a configuration in which the connection portion 20 is parallel to the main surface 3a, the electrode 5 and the region 20a can be reliably joined by surface contact. In a configuration in which the connection portion 50 is parallel to the main surface 3b, the electrode 7 and the region 50a can be reliably joined by surface contact.

The connection portion 20 and the connection portion 50 may have the same shape as viewed from the direction D1.

A configuration in which the connection portion 20 and the connection portion 50 have the same shape as viewed from the direction D1 can reliably and stably support the ceramic body 3.

Each of the ratio of the area of the connection portion 20 to the area of the main surface 3a and the ratio of the area of the connection portion 50 to the area of the main surface 3b may be from 11% to 41%.

A configuration in which each of the above-described area ratios is less than 11% tends not to stably support the ceramic body 3. A configuration in which each of the above-described area ratios is larger than 410% tends not to stabilize a biasing force from the metal terminal MT1 toward the ceramic body 3 and a biasing force from the metal terminal MT2 toward the ceramic body 3. Therefore, a configuration in which each of the above-described area ratios is from 11% to 41% can reliably and stably support the ceramic body 3.

The connection portion 20 and the connection portion 50 may be positioned such that the edge 21a overlaps the connection portion 50 and the edge 51b overlaps the connection portion 20 as viewed from the direction D1. In a view of the connection portion 20 and the connection portion 50 from the direction D1, the ratio of the distance between the edge 21a and the edge 51b to each of the distance between the edge 21a and the edge 21b and the distance between the edge 51a and the edge 51b may be from 48% to 52%.

A configuration in which the above-described distance ratio is less than 48% tends not to stably support the ceramic body 3. A configuration in which the above-described distance ratio is larger than 52% tends not to stabilize a biasing force from the metal terminal MT1 toward the ceramic body 3 and a biasing force from the metal terminal MT2 toward the ceramic body 3. Therefore, a configuration in which the above-described distance ratio is from 48% to 52% can reliably and stably support the ceramic body 3.

The connection portion 20 and the connection portion 50 may be positioned such that the edge 21d overlaps the connection portion 50 and the edge 51c overlaps the connection portion 20 as viewed from the direction D1. In a view of the connection portion 20 and the connection portion 50 from the direction D1, the ratio of the distance between the edge 21d and the edge 51c to each of the distance between the edge 21c and the edge 21d and the distance between the edge 51c and the edge 51d may be from 57% to 72%.

A configuration in which the above-described distance ratio is less than 57% tends not to stably support the ceramic body 3. A configuration in which the above-described distance ratio is larger than 72% tends not to stabilize a biasing force from the metal terminal MT1 toward the ceramic body 3 and a biasing force from the metal terminal MT2 toward the ceramic body 3. Therefore, a configuration in which the above-described distance ratio is from 57% to 72% can reliably and stably support the ceramic body 3.

As will be described below, the electronic component EC1, for example, can provide certain further technical benefits.

In the electronic component EC1, the ceramic body 3 is supported by the metal terminal MT1 connected to the electrode 5 and the metal terminal MT2 connected to the electrode 7.

The connection portion 20 is joined to the electrode 5 in the region 20a, and the connection portion 50 is joined to the electrode 7 in the region 50a. Therefore, a joining area between the connection portion 20 and the electrode 5 and a joining area between the connection portion 50 and the electrode 7 can be maintained.

The region 20a and the region 50a overlap each other as viewed from the direction D1. The region 20b and the region 50b are located on opposite sides with the regions 20a and 50a interposed therebetween as viewed from the direction D1. Therefore, the ceramic body 3 can be stably supported by the metal terminal MT1 (connection portion 20) and the metal terminal MT2 (connection portion 50).

Consequently, the electronic component EC1 can stably and reliably support the ceramic body 3.

An opening OP1 penetrating the region 20a may be formed in the region 20a.

The region 20a and the electrode 5 are joined, for example, by the electrically conductive joining material BM. The electrically conductive joining material BM includes, for example, solder. In a configuration in which the opening OP1 is formed in the region 20a, the electrically conductive joining material BM can be applied to the electrode 5 through the opening OP1. In this configuration, the electrically conductive joining material BM can be easily applied.

The opening OP1 may be located at the center of the main surface 3a as viewed from the direction D1.

The region 20a and the electrode 5 are joined, for example, by the electrically conductive joining material BM. In a configuration in which the opening OP1 is located at the center of the main surface 3a as viewed from the direction D1, the region 20a can be connected to the electrode 5 at the center of the main surface 3a. Therefore, the ceramic body 3 can be supported more stably.

The connection portion 20 may have a polygonal shape as viewed from the direction D1. The region 20a may include the corner CR1₁. The opening OP1 may be located closer to the corner CR1₁.

A configuration in which the opening OP1 is located closer to the corner CR1₁ can easily control the joining area between the connection portion 20 and the electrode 5.

The region 20b may include the corner CR2₁. The bridge portion 40 may be continuous with one of two sides defining the corner CR2₁.

In a configuration in which the bridge portion 40 is continuous with one of the two sides defining the corner CR2₁, this configuration reliably connects the connection portion 20 and the bridge portion 40.

The connection portion 20 may include the region 20c continuous with the region 20a and the region 20b. The region 20c may include the plurality of corners CR3₁. The corner CR11 and the plurality of corners CR3₁ may be curved as viewed from the direction D1.

In a configuration in which the corner CR1₁ and the plurality of corners CR3₁ are curved as viewed from the direction D1, this configuration can mitigate a mismatch between the thermal expansion coefficient of the ceramic body 3 and the thermal expansion coefficient of the metal terminal MT1.

The connection portion 20 may have a rectangular shape.

A configuration in which the connection portion 20 has a rectangular shape can easily realize a configuration in which the region 20a includes the corner CR1₁.

The region 20a may include the surface 22 opposing the electrode 5 and the surface 23 opposing the surface 22. The plurality of protrusions 24 may be provided on the surface 22 of the region 20a along the edge of the opening OP1.

The region 20a and the electrode 5 are joined, for example, by the electrically conductive joining material BM. In a configuration in which the plurality of protrusions 24 are provided on the surface 22 of the region 20a along the edge of the opening OP1, the plurality of protrusions 24 control the spread of the electrically conductive joining material BM. Therefore, this configuration controls a region to which the electrically conductive joining material BM is applied. For example, in a configuration in which the electrically conductive joining material BM includes solder, the plurality of protrusions 24 control the spread of the electrically conductive joining material BM due to the surface tension of the molten solder.

The plurality of protrusions 24 may be provided on the surface 22 of the region 20a along the edge of the opening OP1, except between the edge of the opening OP1 and the corner CR1₁.

In a configuration in which the plurality of protrusions 24 are provided along the edge of the opening OP1, except between the edge of the opening OP1 and the corner CR11, the spread of the electrically conductive joining material BM can be controlled without increasing the number of protrusions 24. This configuration contributes to simplification of the configuration of the metal terminal MT1 (connection portion 20).

The plurality of protrusions 24 may be located at equal intervals.

A configuration in which the plurality of protrusions 24 are located at equal intervals reliably controls the spread of the electrically conductive joining material BM.

The plurality of recesses 25 may be provided at positions corresponding to the plurality of protrusions 24 on the surface 23 of the region 20a.

In a configuration in which the plurality of recesses 25 are provided at positions corresponding to the plurality of protrusions 24 on the surface 23, this configuration can increase the contact area between the region 20a and the exterior body EB. Therefore, this configuration can improve the adhesion between the metal terminal MT1 (connection portion 20) and the exterior body EB.

The bridge portion 40 may be separated from the electrode 5 more than the region 20b in the direction D1.

In a configuration in which the bridge portion 40 is separated from the electrode 5 more than the region 20b in the direction D1, this configuration suppresses the occurrence of an unintended short circuit between the electrode 5 and the electrode 7.

For example, in a configuration in which the metal terminal MT1 includes a plating film, when the electronic component EC1 is solder-mounted, a metal material included in the plating film of the bridge portion 40 may melt and adhere to the ceramic body 3 so as to short-circuit the electrode 5 and the electrode 7.

In contrast, in a configuration in which the bridge portion 40 is separated from the electrode 5 more than the region 20b in the direction D1, a part of the exterior body EB tends to exist between the bridge portion 40 and the electrode 5. Therefore, even when the metal material included in the plating film of the bridge portion 40 melts, this configuration prevents the molten metal material from adhering to the ceramic body 3.

The bridge portion 40 may have a width W2 smaller than a width W1 of the connection portion 20.

In a configuration in which the bridge portion 40 has the width W2, the bridge portion 40 can have an elastic force. The elastic force that the bridge portion 40 has can generate a force toward the ceramic body 3 on the connection portion 20. Therefore, the ceramic body 3 can be supported more stably.

The region 20b may be separated from the electrode 5.

A configuration in which the region 20b is separated from the electrode 5 reliably establishes an electrical and physical connection between the electrode 5 and the metal terminal MT1 in the region 20a.

An opening OP2 penetrating the region 50a may be formed in the region 50a.

The region 50a and the electrode 7 are joined, for example, by the electrically conductive joining material BM. The electrically conductive joining material BM includes, for example, solder. In a configuration in which the opening OP2 is formed in the region 50a, the electrically conductive joining material BM can be applied to the electrode 7 through the opening OP2. In this configuration, the electrically conductive joining material BM can be easily applied.

The opening OP2 may overlap the opening OP1 as viewed from the direction D1.

In a configuration in which the opening OP2 overlaps the opening OP1 as viewed from the direction D1, a region in which the connection portion 20 and the electrode 5 are joined and a region in which the connection portion 50 and the electrode 7 are joined can overlap as viewed from the direction D1. In this configuration, for example, even when the metal terminal MT1 and the metal terminal MT2 expand and contract due to heat, stress is less likely to act on the ceramic body 3 from the metal terminal MT1 and the metal terminal MT2. Therefore, this configuration can suppress a decrease in the mechanical strength of the ceramic body 3.

The opening OP2 may be located at the center of the main surface 3b as viewed from the direction D1.

The region 50a and the electrode 7 are joined, for example, by the electrically conductive joining material BM. In a configuration in which the opening OP2 is located at the center of the main surface 3b as viewed from the direction D1, the region 50a can be connected to the electrode 7 at the center of the main surface 3b. Therefore, the ceramic body 3 can be supported more stably.

The connection portion 50 may have a polygonal shape as viewed from the direction D1. The region 50a may include the corner CR1₂. The opening OP2 may be located closer to the corner CR1₂.

A configuration in which the opening OP2 is located closer to the corner CR1₂ can easily control the joining area between the connection portion 50 and the electrode 7.

The region 50b may include the corner CR2₂. The bridge portion 70 may be continuous with one of two sides defining the corner CR2₂.

In a configuration in which the bridge portion 70 is continuous with one of the two sides defining the corner CR2₂, this configuration reliably connects the connection portion 50 and the bridge portion 70.

The connection portion 50 may include the region 50c continuous with the region 50a and the region 50b. The region 50c may include the plurality of corners CR3₂. The corner CR1₂ and the plurality of corners CR3₂ may be curved as viewed from the direction D1.

In a configuration in which the corner CR1₂ and the plurality of corners CR3₂ are curved as viewed from the direction D1, this configuration can mitigate a mismatch between the thermal expansion coefficient of the ceramic body 3 and the thermal expansion coefficient of the metal terminal MT2.

The connection portion 50 may have a rectangular shape.

A configuration in which the connection portion 50 has a rectangular shape can easily realize a configuration in which the region 50a includes the corner CR1₂.

The region 50a may include the surface 52 opposing the electrode 7 and the surface 53 opposing the surface 52. The plurality of protrusions 54 may be provided on the surface 52 of the region 50a along the edge of the opening OP2.

The region 50a and the electrode 7 are joined, for example, by the electrically conductive joining material BM. In a configuration in which the plurality of protrusions 54 are provided on the surface 52 of the region 50a along the edge of the opening OP2, the plurality of protrusions 54 control the spread of the electrically conductive joining material BM. Therefore, this configuration controls a region to which the electrically conductive joining material BM is applied. For example, in a configuration in which the electrically conductive joining material BM includes solder, the plurality of protrusions 54 control the spread of the electrically conductive joining material BM due to the surface tension of the molten solder.

The plurality of protrusions 54 may be provided on the surface 52 of the region 50a along the edge of the opening OP2, except between the edge of the opening OP2 and the corner CR1₂.

In a configuration in which the plurality of protrusions 54 are provided along the edge of the opening OP2, except between the edge of the opening OP2 and the corner CR1₂, the spread of the electrically conductive joining material BM can be controlled without increasing the number of protrusions 54. This configuration contributes to simplification of the configuration of the metal terminal MT2 (connection portion 50).

The plurality of protrusions 54 may be located at equal intervals.

A configuration in which the plurality of protrusions 54 are located at equal intervals reliably controls the spread of the electrically conductive joining material BM.

The plurality of recesses 55 may be provided at positions corresponding to the plurality of protrusions 54 on the surface 53 of the region 50a.

The bridge portion 70 may be separated from the electrode 7 more than the region 50b in the direction D1.

In a configuration in which the bridge portion 70 is separated from the electrode 7 more than the region 50b in the direction D1, this configuration suppresses the occurrence of an unintended short circuit between the electrode 7 and the electrode 5.

For example, in a configuration in which the metal terminal MT2 includes a plating film, when the electronic component EC1 is solder-mounted, a metal material included in the plating film of the bridge portion 70 may melt and adhere to the ceramic body 3 so as to short-circuit the electrode 7 and the electrode 5.

In contrast, in a configuration in which the bridge portion 70 is separated from the electrode 7 more than the region 50b in the direction D1, a part of the exterior body EB tends to exist between the bridge portion 70 and the electrode 7. Therefore, even when the metal material included in the plating film of the bridge portion 70 melts, this configuration prevents the molten metal material from adhering to the ceramic body 3.

The bridge portion 70 may have a width W4 smaller than a width W3 of the connection portion 50.

In a configuration in which the bridge portion 70 has the width W4, the bridge portion 70 can have an elastic force. The elastic force that the bridge portion 70 has can generate a force toward the ceramic body 3 on the connection portion 50. Therefore, the ceramic body 3 can be supported more stably.

The region 50b may be separated from the electrode 7.

A configuration in which the region 50b is separated from the electrode 7 reliably establishes an electrical and physical connection between the electrode 7 and the metal terminal MT2 in the region 50a.

The ceramic body 3 may be sandwiched by the metal terminals MT1 and MT2. Each of the ratio of the area of the connection portion 20 to the area of the main surface 3a and the ratio of the area of the connection portion 50 to the area of the main surface 3b may be from 11% to 41%.

A configuration in which each of the above-described area ratios is less than 11% tends not to stably support the ceramic body 3. A configuration in which each of the above-described area ratios is larger than 410% tends not to stabilize a biasing force from the metal terminal MT1 toward the ceramic body 3 and a biasing force from the metal terminal MT2 toward the ceramic body 3. Therefore, a configuration in which each of the above-described area ratios is from 11% to 41% can reliably and stably support the ceramic body 3.

The ceramic body 3 may be sandwiched by the metal terminals MT1 and MT2. The connection portion 20 and the connection portion 50 may be positioned such that the edge 21a overlaps the connection portion 50 and the edge 51b overlaps the connection portion 20 as viewed from the direction D1. In a view of the connection portion 20 and the connection portion 50 from the direction D1, the ratio of the distance between the edge 21a and the edge 51b to each of the distance between the edge 21a and the edge 21b and the distance between the edge 51a and the edge 51b may be from 48% to 52%.

A configuration in which the above-described distance ratio is less than 48% tends not to stably support the ceramic body 3. A configuration in which the above-described distance ratio is larger than 52% tends not to stabilize a biasing force from the metal terminal MT1 toward the ceramic body 3 and a biasing force from the metal terminal MT2 toward the ceramic body 3. Therefore, a configuration in which the above-described distance ratio is from 48% to 52% can reliably and stably support the ceramic body 3.

The ceramic body 3 may be sandwiched by the metal terminals MT1 and MT2. The connection portion 20 and the connection portion 50 may be positioned such that the edge 21d overlaps the connection portion 50 and the edge 51c overlaps the connection portion 20 as viewed from the direction D1. In a view of the connection portion 20 and the connection portion 50 from the direction D1, the ratio of the distance between the edge 21d and the edge 51c to each of the distance between the edge 21c and the edge 21d and the distance between the edge 51c and the edge 51d may be from 57% to 72%.

A configuration in which the above-described distance ratio is less than 57% tends not to stably support the ceramic body 3. A configuration in which the above-described distance ratio is larger than 72% tends not to stabilize a biasing force from the metal terminal MT1 toward the ceramic body 3 and a biasing force from the metal terminal MT2 toward the ceramic body 3. Therefore, a configuration in which the above-described distance ratio is from 57% to 72% can reliably and stably support the ceramic body 3.

The electronic component EC1 may include the exterior body EB.

A configuration including the exterior body EB described above improves the reliability of the electronic component EC1.

It is to be understood that not all aspects, advantages and features described herein may necessarily be achieved by, or included in, any one particular example. Indeed, having described and illustrated various examples herein, it should be apparent that other examples may be modified in arrangement and detail.

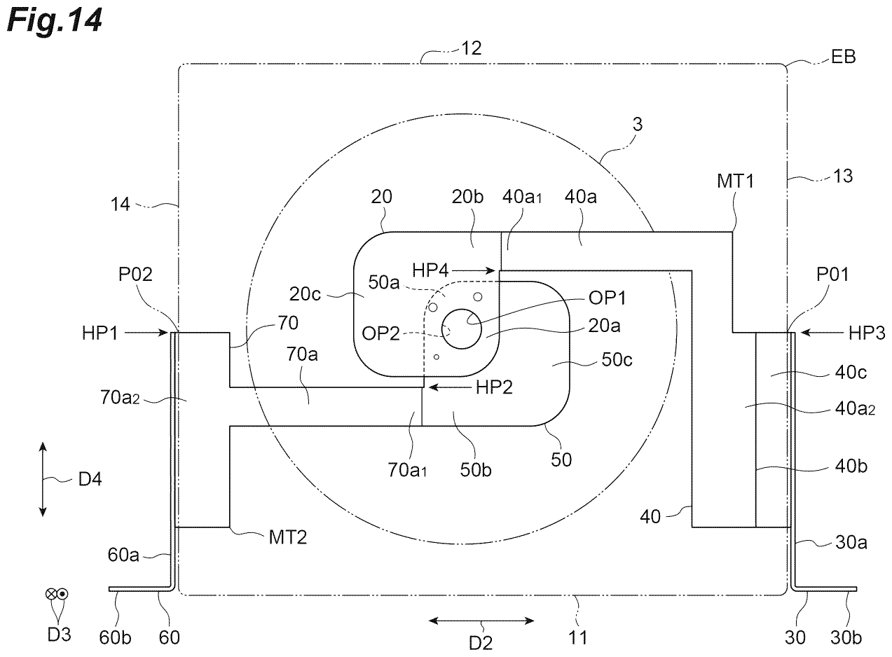

As illustrated in FIG. 14, the regions 30b and 60b may not oppose the side surface 11. The region 30b may intersect the region 30a and extend in a direction away from the exterior body EB. In a configuration in which the region 30b intersects the region 30a and extends in a direction away from the exterior body EB, the recess 18 may not be provided in the side surface 11. The region 60b may intersect the region 60a and extend in a direction away from the exterior body EB. In a configuration in which the region 60b intersects the region 60a and extends in a direction away from the exterior body EB, the recess 19 may not be provided in the side surface 11. FIG. 14 is a diagram illustrating a modification of a pair of metal terminals.

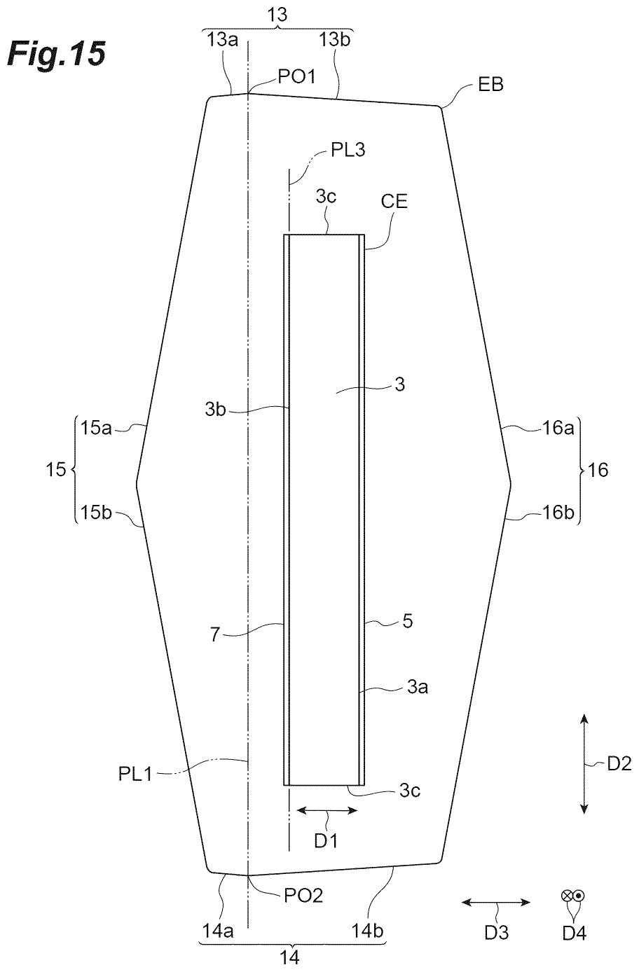

As illustrated in FIG. 15, an angle formed by the plane PL1 and the plane PL3 including the main surface 3b may be 0°. That is, the plane PL1 and the plane PL3 may be parallel. In a configuration in which the angle formed by the plane PL1 and the plane PL3 including the main surface 3b is 0°, the direction D1 and the direction D4 may coincide with each other. However, as described above, in a configuration in which the angle formed by the plane PL1 and the plane PL3 is larger than 0° and 3° or less, the ceramic body 3 can be reliably and stably supported. FIG. 15 is a schematic diagram illustrating a configuration of a ceramic element and an exterior body.

What is claimed is:

1. An electronic component, comprising:
a ceramic body including a first main surface and a second main surface opposing each other and a side surface coupling the first main surface and the second main surface;
a first electrode disposed on the first main surface;
a second electrode disposed on the second main surface;
a first metal terminal connected to the first electrode;
a second metal terminal connected to the second electrode; and
an exterior body covering the ceramic body, the first electrode, the second electrode, a part of the first metal terminal, and a part of the second metal terminal, wherein
the exterior body includes a third main surface that opposes the side surface and is arranged to constitute a mounting surface, and a first side surface and a second side surface that oppose the side surface, are adjacent to the third main surface, and oppose each other,
the first metal terminal is exposed from the exterior body at the first side surface, and includes a first inner portion located in the exterior body and a first outer portion located outside the exterior body,
the second metal terminal is exposed from the exterior body at the second side surface, and includes a second inner portion located in the exterior body and a second outer portion located outside the exterior body,
the ceramic body is located on one side of a plane that is perpendicular to the third main surface and includes a first position on the first side surface at which the first metal terminal is exposed and a second position on the second side surface at which the second metal terminal is exposed,
the ceramic body and the first outer portion are configured such that the ceramic body and the first outer portion overlap each other in a view from a side of the first side surface in a direction parallel to the third main surface and the plane, and
the ceramic body and the second outer portion are configured such that the ceramic body and the second outer portion overlap each other in a view from a side of the second side surface in a direction parallel to the third main surface and the plane.

2. The electronic component according to claim 1, wherein
the ceramic body and the first inner portion are configured such that the ceramic body and the first inner portion overlap each other in a view from a side of the first side surface in a direction parallel to the third main surface and the plane, and
the ceramic body and the second inner portion are configured such that the ceramic body and the second inner portion do not overlap each other in a view from a side of the second side surface in a direction parallel to the third main surface and the plane.

3. The electronic component according to claim 1, wherein
the exterior body includes a third side surface opposing the second main surface in a direction perpendicular to the plane, and a fourth side surface opposing the first main surface in the direction perpendicular to the plane, and
in the direction perpendicular to the plane, a distance between the fourth side surface and the ceramic body is larger than a distance between the third side surface and the ceramic body.

4. The electronic component according to claim 1, wherein
the first inner portion includes a first connection portion connected to the first electrode, and a first bridge portion bridging the first connection portion and the first outer portion,
the second inner portion includes a second connection portion connected to the second electrode, and a second bridge portion bridging the second connection portion and the second outer portion,
the first bridge portion includes:
a first region extending to oppose the first main surface;
a second region that is continuous with the first region and extends to oppose the side surface of the ceramic body; and
a third region that is continuous with the second region and extends toward the first side surface in a direction intersecting a direction in which the second region extends, and
the second bridge portion includes a fourth region extending to oppose the second main surface.

5. The electronic component according to claim 4, wherein
the first connection portion and the second connection portion have a rectangular shape as viewed from a direction in which the first main surface and the second main surface oppose each other, and are located such that one corner of the rectangular shape had by the first connection portion and one corner of the rectangular shape had by the second connection portion overlap each other in the direction in which the first main surface and the second main surface oppose each other,
the first bridge portion is connected to another corner that is adjacent to the one corner overlapping the second connection portion and is exposed from the second connection portion, among a plurality of corners of the rectangular shape had by the first connection portion, and
the second bridge portion is connected to another corner that is adjacent to the one corner overlapping the first connection portion and is exposed from the first connection portion, among a plurality of corners of the rectangular shape had by the second connection portion.

6. The electronic component according to claim 5, wherein
the first region includes a region including an end closer to the first connection portion and a region including an end closer to the second region, and has an L-shape as viewed from the direction in which the first main surface and the second main surface oppose each other, and
the fourth region includes a region including an end closer to the second connection portion and a region including an end closer to the second outer portion, and has a T-shape as viewed from the direction in which the first main surface and the second main surface oppose each other.

7. The electronic component according to claim 5, wherein
the first connection portion is connected to the first electrode in a region overlapping the second connection portion in the direction in which the first main surface and the second main surface oppose each other, and
the second connection portion is connected to the second electrode in a region overlapping the first connection portion in the direction in which the first main surface and the second main surface oppose each other.

8. The electronic component according to claim 5, wherein
the one corner of the first connection portion to which the first bridge portion is connected and the one corner of the second connection portion to which the second bridge portion is connected are located on opposite sides with a region in which the first connection portion and the second connection portion overlap each other interposed therebetween, as viewed from the direction in which the first main surface and the second main surface oppose each other.

9. The electronic component according to claim 4, wherein
the first region is separated from the first electrode,
the first bridge portion includes a region connecting the first region and the first connection portion,
the fourth region is separated from the second electrode, and
the second bridge portion includes a region connecting the fourth region and the second connection portion.

10. The electronic component according to claim 1, wherein
the exterior body includes a third side surface opposing the second main surface in a direction perpendicular to the plane, and a fourth side surface opposing the first main surface in the direction perpendicular to the plane,
each of the first side surface and the second side surface includes a first surface region located closer to the third side surface than the plane, and a second surface region located closer to the fourth side surface than the plane,
the first surface regions included in the first side surface and the second side surface are inclined such that a distance between the first surface regions decreases with increasing distance from the plane, and
the second surface regions included in the first side surface and the second side surface are inclined such that a distance between the second surface regions decreases with increasing distance from the plane.

11. The electronic component according to claim 1, wherein
the exterior body includes a third side surface opposing the second main surface in a direction perpendicular to the plane, and a fourth side surface opposing the first main surface in the direction perpendicular to the plane, and
the ceramic body is located closer to the fourth side surface than the plane.

12. The electronic component according to claim 11, wherein
in the direction perpendicular to the plane, a distance between the plane and the fourth side surface is larger than a distance between the plane and the third side surface.

13. The electronic component according to claim 12, wherein
the first outer portion includes an outer region extending from the first position along the first side surface, and
the second outer portion includes an outer region extending from the second position along the second side surface.

14. The electronic component according to claim 1, wherein
the exterior body includes a third side surface opposing the second main surface in a direction perpendicular to the plane, and a fourth side surface opposing the first main surface in the direction perpendicular to the plane,
each of the third side surface and the fourth side surface includes a first surface region located closer to the first side surface and a second surface region located closer to the second side surface,
the first surface regions included in the third side surface and the fourth side surface are inclined relative to the plane such that a distance between the first surface regions decreases with decreasing distance to the first side surface, and
the second surface regions included in the third side surface and the fourth side surface are inclined relative to the plane such that a distance between the second surface regions decreases with decreasing distance to the second side surface.

15. The electronic component according to claim 1, wherein
the first outer portion includes a first outer region along the first side surface and a second outer region extending in a direction intersecting the first outer region, and
the second outer portion includes a third outer region along the second side surface and a fourth outer region extending in a direction intersecting the third outer region.

16. The electronic component according to claim 15, wherein
the second outer region and the fourth outer region are along the third main surface, and
the third main surface is provided with a recess at each of a position corresponding to the second outer region and a position corresponding to the fourth outer region.
